(19) United States
(12) Patent Application Publication
(10) Pub. No.: US 2007/0232733 A1
(43) Pub. Date: Oct. 4, 2007

(54) Microgels in Crosslinkable Organic Media

(76) Inventors: Torsten Ziser, Birkenau (DE); Thomas Fruh, Limburgerhof (DE); Ludger Heiliger, Neustadt (DE); Werner Obrecht, Moers (DE)

Correspondence Address: LANXESS CORPORATION, 111 RIDC PARK WEST DRIVE, PITTSBURGH, PA, 15275-1112, US

(21) Appl. No.: 10/573,217

(22) PCT Filed: Sep. 23, 2004
(86) PCT No.: PCT/EP04/52294

§ 371 Date: May 4, 2007

(30) Foreign Application Priority Data
Sep. 27, 2003 (DE) 103 44 976.0

(51) Int. Cl. C08J 3/24

(52) U.S. Cl. 524/386

(57) ABSTRACT

The invention relates to a composition comprising at least one specific organic crosslinkable medium and at least one microgel that has not been crosslinked by means of high-energy radiation, to processes for their preparation, to uses of the compositions, to microgel-containing polymers prepared therefrom, and to moulded bodies or coatings produced therefrom.

The invention relates to a composition comprising at least one specific organic crosslinkable medium and at least one microgel that has not been crosslinked by means of high-energy radiation, to processes for its preparation, to uses of the compositions, to microgel-containing polymers prepared therefrom, and to moulded bodies or coatings produced therefrom.

It is known to use rubber gels, including modified rubber gels, in blends with a very wide variety of rubbers in order, for example, to improve the rolling resistance in the production of motor vehicle tyres (see e.g. DE 42 20 563, GB-PS 10 78 400, EP 405 216 and EP 854 171). In these cases the rubber gels are always incorporated into solid matrices.

It is also known to incorporate printing ink pigments in finely divided form into liquid media suitable therefor, in order ultimately to produce printing inks (see e.g. EP 0 953 615 A2, EP 0 953 615 A3). Particle sizes of as little as 100 nm are achieved hereby.

Various dispersing apparatuses such as bead mills, three-roller mills or homogenisers can be used for the dispersion. The use of homogenisers and the operation thereof is described in the Marketing Bulletin of APV Homogeniser Group—“High-pressure homogenisers processes, product and applications” by William D. Pandolfe and Peder Baekgaard, principally for the homogenisation of emulsions.

The mentioned documents do not describe the use of rubber gels as the solids component in mixtures with crosslinkable organic media having a specific viscosity, with the aim of producing very finely divided rubber-gel dispersions having particle diameters markedly below one μm, and their homogenisation by means of a homogeniser

Chinese Journal of Polymer Science, Volume 20, No. 2, (2002), 93-98 describes microgels fully crosslinked by means of high-energy radiation and their use for increasing the impact strength of plastics. In the preparation of specific epoxy resin compositions, a mixture of a radiation-crosslinked carboxyl-terminated nitrile-butadiene microgel and the diglycidyl ether of bisphenol A is formed as intermediate. Further liquid microgel-containing compositions are not described.

Similarly, US 20030088036 A1 discloses reinforced heat-curing resin compositions, the preparation of which likewise comprises mixing radiation-crosslinked microgel particles with heat-curing prepolymers (see also EP 1262510 A1).

In these publications, a radioactive cobalt source is described as the preferred radiation source for the preparation of the microgel particles.

The use of radiation crosslinking yields microgel particles that are crosslinked very homogeneously. However, this type of crosslinking has the particular disadvantage that this process cannot realistically be transferred from the laboratory scale to a large-scale installation, either from the economic point of view or from the point of view of working safety. Microgels that have not been crosslinked by means of high-energy radiation are not used in the mentioned publications. Furthermore, when using microgels that have been fully crosslinked by radiation, the change in modulus from the matrix phase to the dispersed phase is immediate. As a result, sudden stress can cause tearing effects between the matrix and the dispersed phase, with the result that the mechanical properties, the swelling behaviour and the stress corrosion cracking, etc. are impaired.

The mentioned publications contain no mention of the use of microgels that have not been crosslinked by means of high-energy radiation.

DE 2910153 and DE 2910168 disclose dispersions of rubber particles with monomers. These are prepared by adding the monomers to an aqueous rubber latex with addition of a dispersing agent. Although these specifications also mention the possibility of removing resulting water from the latex, anhydrous dispersions are not described. It is virtually impossible to obtain dispersions that are anhydrous according to this process (see also the appraisal in DE-A-3742180, page 2, line 10 of the same applicant). However, this is a disadvantage in many applications. Furthermore, the dispersions described in the mentioned patents necessarily contain dispersing agents or emulsifiers in order to achieve homogeneous distribution of the aqueous and the organic phases. However, the presence of such emulsifiers or dispersing agents is very disruptive in many applications. In addition, the rubber particles described therein are relatively coarse-grained.

The inventors of the present invention have now found that microgels that have not been crosslinked by means of high-energy radiation can be finely distributed in crosslinkable organic media having a specific viscosity, for example using a homogeniser. The division of the microgels in the crosslinkable organic medium to the primary particle range is, for example, a requirement for utilising, especially in a reproducible manner, the nano properties of the microgels in applications of any kind, for example in incorporation into plastics. As a result of the fine dispersion it is possible to establish critical application-related properties in a reproducible manner. The compositions according to the invention comprising the specific microgels and crosslinkable organic media are able to open up a large number of novel applications for microgels which were hitherto not accessible with the microgels themselves.

Accordingly, the microgel-containing liquids open up new application possibilities, such as, for example, casting, injection moulding, coating, for which the liquid state is a requirement.

By polymerisation of the compositions according to the invention containing crosslinkable organic media and microgel it is possible, owing to the fine distributions that are achievable, to obtain, for example, plastics having completely new properties. The microgel-containing compositions according to the invention can be used in a large number of fields, such as, for example, in elastomeric PU systems (cold-casting systems and hot-casting systems).

In the microgel-containing compositions according to the invention, materials that are incompatible per se surprisingly form a homogeneous distribution which remains stable even on prolonged storage (6 months).

P. Pötschke et al., Kautschuk Gummi Kunststoffe, 50 (11) (1997) 787 have shown that, with incompatible materials such as, for example, p-phenylenediamine derivative as the dispersed phase and TPU as the surrounding phase, it is not possible to obtain domains smaller than 1.5 μm. It is surprising that, with the microgels of the present invention, such small dispersed phases having the size of the primary particles (<100 nm) are achieved.

Microgel-containing compositions of crosslinkable media have also been found for which very different rheological behaviour has been demonstrated. In suitable microgel-containing compositions, a very strong intrinsic viscosity or thixotropy has surprisingly been found. This can be used to control the flow behaviour, as well as other properties, of any desired liquid crosslinkable compositions in a targeted manner by means of microgels. This can advantageously be used, for example, in the case of filler-containing compositions, which tend to form a sediment. Furthermore, plastics produced from the microgel-containing compositions according to the invention have surprisingly been found to have improved tear strength and improved reinforcement, expressed as the ratio of the tensile stresses at 300% and 100% elongation. Furthermore, the hardness of the resulting polymer compositions can be adjusted by the choice of the glass transition temperature of the microgel.

The present invention accordingly provides a composition comprising at least one crosslinkable organic medium (A) that has a viscosity of less than 30,000 mPas at a temperature of 120° C., and at least one microgel (B) that has not been crosslinked by means of high-energy radiation.

Preferably, the viscosity of the crosslinkable organic medium (A) at a temperature of 120° C. is less than 10,000 mPas.

More preferably, the viscosity of the crosslinkable organic medium (A) at a temperature of 120° C. is less than 1000 mPas.

Yet more preferably, the viscosity of the crosslinkable organic medium (A) is less than 750 mPas at a temperature of 120° C., even more preferably less than 500 mPas at a temperature of 120° C.

The viscosity of the crosslinkable organic medium (A) is determined at a speed of 5 s⁻¹ using a cone/plate measuring system according to DIN 53018 at 120° C.

Microgels (B)

The microgel (B) used in the composition according to the invention is a microgel that has not been crosslinked by means of high-energy radiation. High-energy radiation here advantageously means electromagnetic radiation having a wavelength of less than 0.1 μm.

The use of microgels that have been fully homogeneously crosslinked by means of high-energy radiation is disadvantageous because it is virtually impossible to carry out on an industrial scale and gives rise to problems related to working safety. Furthermore, in compositions prepared using microgels that have been fully homogeneously crosslinked by means of high-energy radiation, sudden stress causes tearing effects between the matrix and the dispersed phase, with the result that the mechanical properties, the swelling behaviour and the stress corrosion cracking, etc. are impaired.

In a preferred embodiment of the invention, the primary particles of the microgel (B) exhibit approximately spherical geometry. According to DIN 53206:1992-08, primary particles are the microgel particles dispersed in the coherent phase which can be individually recognised by means of suitable physical processes (electron microscope) (see e.g. Römpp Lexikon, Lacke und Druckfarben, Georg Thieme Verlag, 1998). An “approximately spherical” geometry means that the dispersed primary particles of the microgels recognisably have substantially a circular surface when the composition is viewed, for example, using an electron microscope. Because the form of the microgels does not change substantially during crosslinking of the crosslinkable organic medium (A), the comments made hereinabove and hereinbelow apply in the same manner also to the microgel-containing compositions obtained by crosslinking of the composition according to the invention.

In the primary particles of the microgel (B) present in the composition according to the invention, the variation in the diameters of an individual primary particle, defined as
[(d1−d2)/d2]×100,

wherein d1 and d2 are any two diameters of the primary particle and d1>d2, is preferably less than 250%, more preferably less than 200%, yet more preferably less than 100%, even more preferably less than 80%, still more preferably less than 50%.

Preferably at least 80%, more preferably at least 90%, yet more preferably at least 95%, of the primary particles of the microgel exhibit a variation in the diameters, defined as
[(d1−d2)/d2]×100,

wherein d1 and d2 are any two diameters of the primary particle and d1>d2, of less than 250%, more preferably less than 200%, yet more preferably less than 100%, even more preferably less than 80%, still more preferably less than 50%.

The above-mentioned variation in the diameters of the individual particles is determined by the following process. A thin section of the composition according to the invention is first prepared as described in the Examples. An image is then recorded by transmission electron microscopy at a magnification of, for example, 10,000 times or 200,000 times. In an area of 833.7 nm×828.8 nm, the largest and smallest diameters d1 and d2 are determined on 10 microgel primary particles. If the variation is less than 250%, more preferably less than 100%, yet more preferably less than 80%, even more preferably less than 50%, in at least 80%, more preferably at least 90%, yet more preferably at least 95%, of the measured microgel primary particles, then the microgel primary particles exhibit the above-defined feature of variation.

If the concentration of the microgels in the composition is so high that pronounced overlapping of the visible microgel primary particles occurs, the evaluatability can be improved by previously diluting the measuring sample in a suitable manner. In the composition according to the invention, the primary particles of the microgel (B) preferably have an average particle diameter of from 5 to 500 nm, more preferably from 20 to 400 nm, more preferably from 20 to 300 nm, more preferably from 20 to 250 nm, yet more preferably from 20 to 99 nm, yet more preferably from 40 to 80 nm (diameter data according to DIN 53206). The preparation of particularly finely divided microgels by emulsion polymerisation is carried out by controlling the reaction parameters in a manner known per se (see e.g. H. G. Elias, Makromoleküle, Volume 2, Technologie, 5th Edition, 1992, page 99ff).

Because the morphology of the microgels remains substantially unchanged during polymerisation or crosslinking of the composition according to the invention, the average particle diameter of the dispersed primary particles corresponds substantially to the average particle diameter of the dispersed primary particles in the composition obtained by polymerisation or crosslinking.

In the composition according to the invention, the microgels (B) advantageously contain at least about 70 wt. %, more preferably at least about 80 wt. %, yet more preferably at least about 90 wt. %, portions that are insoluble in toluene at 23° C. (gel content). The portion that is insoluble in toluene is determined in toluene at 23° C. For this purpose, 250 mg of the microgel are swelled in 20 ml of toluene at 23° C. for 24 hours, with shaking. After centrifugation at 20,000 rpm, the insoluble portion is separated off and dried. The gel content is obtained from the difference between the dried residue and the weighed portion and is given in percent by weight.

In the composition according to the invention, the microgels (B) advantageously exhibit a swelling index in toluene at 23° C. of less than about 80, more preferably of less than 60, yet more preferably of less than 40. For example, the swelling indices of the microgels (Qi) can particularly preferably be between 1-15 and 1-10. The swelling index is calculated from the weight of the solvent-containing microgel swelled in toluene at 23° C. for 24 hours (after centrifugation at 20,000 rpm) and the weight of the dry microgel:
Qi=wet weight of the microgel/dry weight of the microgel.

In order to determine the swelling index, 250 mg of the microgel are allowed to swell in 25 ml of toluene for 24 hours, with shaking. The gel is removed by centrifugation and weighed while wet and then dried at 70° C. until a constant weight is reached and then weighed again.

In the composition according to the invention, the microgels (B) advantageously have glass transition temperatures Tg of from −100° C. to +120° C., more preferably from −100° C. to +100° C., yet more preferably from −80° C. to +80° C. In rare cases it is also possible to use microgels which, on account of their high degree of crosslinking, do not have a glass transition temperature.

Glass transition temperatures of the microgels (B) below room temperature (20°) are particularly advantageous for leaving the tear strength and hardness of microgel-containing polymer compositions largely unaffected, while the rheology of the compositions to be polymerised is influenced in the desired manner.

Glass transition temperatures of the microgels (B) above room temperature (20°) are advantageous for achieving increased hardness, greater reinforcement, improved tear strength in microgel-containing polymer compositions and influencing in the desired manner the rheology of the compositions to be polymerised.

Furthermore, the microgels (B) used in the composition according to the invention advantageously have a breadth of the glass transition of greater than 5° C., preferably greater than 10° C., more preferably greater than 20° C. Microgels that have such a breadth of the glass transition are generally not fully homogeneously crosslinked—in contrast to fully homogeneously radiation-crosslinked microgels. This has the result that the change in modulus from the matrix phase to the dispersed phase in the crosslinkable or polymerised compositions prepared from the compositions according to the invention is not immediate. As a result, sudden stress on these compositions does not lead to tearing effects between the matrix and the dispersed phase, with the result that the mechanical properties, the swelling behaviour and the stress corrosion cracking, etc. are advantageously affected.

The glass transition temperatures (Tg) and the breadth of the glass transition (ΔTg) of the microgels are determined by differential scanning calorimetry (DSC) under the following conditions:

For determining Tg and ΔTg, two cooling/heating cycles are carried out. Tg and ΔTg are determined in the second heating cycle. For the determinations, 10 to 12 mg of the chosen microgel are placed in a DSC sample container (standard aluminium ladle) from Perkin-Elmer. The first DSC cycle is carried out by first cooling the sample to −100° C. with liquid nitrogen and then heating it to +150° C. at a rate of 20 K/min. The second DSC cycle is begun by immediately cooling the sample as soon as a sample temperature of +150° C. has been reached. Cooling is carried out at a rate of about 320 K/min. In the second heating cycle, the sample is again heated to +150° C., as in the first cycle. The rate of heating in the second cycle is again 20 K/min. Tg and ΔTg are determined graphically on the DSC curve of the second heating operation. To that end, three straight lines are plotted on the DSC curve. The first straight line is plotted on the part of the DSC curve below Tg, the second straight line is plotted on the branch of the curve passing through Tg with the point of inflection, and the third straight line is plotted on the branch of the DSC curve above Tg. Three straight lines with two points of intersection are thus obtained. The two points of intersection are each characterised by a characteristic temperature. The glass transition temperature Tg is obtained as the mean of these two temperatures, and the breadth of the glass transition ΔTg is obtained from the difference between the two temperatures.

The microgels (B) present in the composition according to the invention, which microgels have not been crosslinked by means of high-energy radiation and are preferably based on homopolymers or random copolymers, can be prepared in a manner known per se (see, for example, EP-A-405 216, EP-A-854171, DE-A 4220563, GB-PS 1078400, DE 197 01 489.5, DE 197 01 488.7, DE 198 34 804.5, DE 198 34 803.7, DE 198 34 802.9, DE 199 29 347.3, DE 19939865.8, DE 199 42 620.1, DE 199 42 614.7, DE 100 21 070.8, DE 10038 488.9, DE 100 39 749.2, DE 100 52 287.4, DE 100 56 311.2 and DE 100 61174.5). In patent (applications) EP-A 405 216, DE-A 4220563 and in GB-PS 1078400, the use of CR, BR and NBR microgels in mixtures with double-bond-containing rubbers is claimed. DE 197 01 489.5 describes the use of subsequently modified microgels in mixtures with double-bond-containing rubbers such as NR, SBR and BR.

Microgels are advantageously understood as being rubber particles which are obtained especially by crosslinking the following rubbers:

| | |
|---|---|
| BR: | polybutadiene |
| ABR: | butadiene/acrylic acid C1-4 alkyl ester copolymers |
| IR: | polyisoprene |
| SBR: | styrene-butadiene copolymerisation products having styrene |
| | contents of from 1 to 90 wt. %, preferably from 5 to 50 wt. % |
| X-SBR: | carboxylated styrene-butadiene copolymerisation products |
| FKM: | fluorine rubber |
| ACM: | acrylate rubber |
| NBR: | polybutadiene-acrylonitrile copolymerisation products having |
| | acrylonitrile contents of from 5 to 60 wt. %, preferably from 10 |
| | to 50 wt. % |
| X-NBR: | carboxylated nitrile rubbers |
| CR: | polychloroprene |
| IIR: | isobutylene/isoprene copolymerisation products having |
| | isoprene contents of from 0.5 to 10 wt. % |
| BIIR: | brominated isobutylene/isoprene copolymerisation products |
| | having bromine contents of from 0.1 to 10 wt. % |
| CIIR: | chlorinated isobutylene/isoprene copolymerisation products |
| | having bromine contents of from 0.1 to 10 wt. % |
| HNBR: | partially and completely hydrogenated nitrile rubbers |
| EPDM: | ethylene-propylene-diene copolymerisation products |
| EAM: | ethylene/acrylate copolymers |
| EVM: | ethylene/vinyl acetate copolymers |
| CO and | epichlorohydrin rubbers |
| ECO: | |
| Q: | silicone rubbers |
| AU: | polyester urethane polymerisation products |
| EU: | polyether urethane polymerisation products |
| ENR: | epoxidised natural rubber or mixtures thereof. |

The preparation of the uncrosslinked microgel starting products is advantageously carried out by the following methods:
1. emulsion polymersation
2. solution polymerisation of rubbers which are not obtainable by variant 1,
3. naturally occurring latices, such as, for example, natural rubber latex, can additionally be used.

The microgels (B) used in the composition according to the invention are preferably those that are obtainable by emulsion polymerisation and crosslinking.

The following free-radically polymerisable monomers, for example, are used in the preparation of the microgels used according to the invention by emulsion polymerisation: butadiene, styrene, acrylonitrile, isoprene, esters of acrylic and methacrylic acid, tetrafluoroethylene, vinylidene fluoride, hexafluoropropene, 2-chlorobutadiene, 2,3-dichlorobutadiene, and also double-bond-containing carboxylic acids, such as, for example, acrylic acid, methacrylic acid, maleic acid, itaconic acid, etc., double-bond-containing hydroxy compounds, such as, for example, hydroxyethyl methacrylate, hydroxyethyl acrylate, hydroxybutyl methacrylate, amine-functionalised (meth)acrylates, acrolein, N-vinyl-2-pyrrolidone, N-allyl-urea and N-allyl-thiourea, and also secondary amino(meth)acrylic acid esters, such as 2-tert.-butylaminoethyl methacrylate and 2-tert.-butylaminoethylmethacrylamide, etc. Crosslinking of the rubber gel can be achieved directly during the emulsion polymerisation, such as by copolymerisation with multifunctional compounds having crosslinking action, or by subsequent crosslinking as described hereinbelow. The use of directly crosslinked microgels constitutes a preferred embodiment of the invention.

Preferred multifunctional comonomers are compounds having at least two, preferably from 2 to 4, copolymerisable C═C double bonds, such as diisopropenylbenzene, divinylbenzene, divinyl ethers, divinylsulfone, diallyl phthalate, triallyl cyanurate, triallyl isocyanurate, 1,2-polybutadiene, N,N′-m-phenylenemaleimide, 2,4-toluoylenebis(maleimide) and/or triallyl trimellitate. There come into consideration also the acrylates and methacrylates of polyhydric, preferably di- to tetra-hydric, C2 to C10 alcohols, such as ethylene glycol, 1,2-propanediol, butanediol, hexanediol, polyethylene glycol having from 2 to 20, preferably from 2 to 8, oxyethylene units, neopentyl glycol, bisphenol A, glycerol, trimethylolpropane, pentaerythritol, sorbitol, with unsaturated polyesters of aliphatic diols and polyols, as well as maleic acid, fumaric acid and/or itaconic acid.

Crosslinking to form rubber microgels during the emulsion polymerisation can also be effected by continuing the polymerisation to high conversions or by the monomer feed process by polymerisation with high internal conversions. Another possibility consists in carrying out the emulsion polymerisation in the absence of regulators.

For the crosslinking of the uncrosslinked or weakly crosslinked microgel starting products following the emulsion polymerisation there are best used latices which are obtained in the emulsion polymerisation. In principle, this method can also be used with non-aqueous polymer dispersions which are obtainable by other means, e.g. by recrystallisation. Natural rubber latices can also be crosslinked in this manner.

Suitable chemicals having crosslinking action are, for example, organic peroxides, such as dicumyl peroxide, tert.-butylcumyl peroxide, bis-(tert.-butyl-peroxy-isopropyl)benzene, di-tert.-butyl peroxide, 2,5-dimethylhexane 2,5-dihydroperoxide, 2,5-dimethylhexine 3,2,5-dihydroperoxide, dibenzoyl peroxide, bis-(2,4-dichlorobenzoyl) peroxide, tert.-butyl perbenzoate, and also organic azo compounds, such as azo-bis-isobutyronitrile and azo-bis-cyclohexanenitrile, and also di- and poly-mercapto compounds, such as dimercaptoethane, 1,6-dimercaptohexane, 1,3,5-trimercaptotriazine and mercapto-terminated polysulfide rubbers, such as mercapto-terminated reaction products of bis-chloroethylformal with sodium polysulfide.

The optimum temperature for carrying out the post-crosslinking is naturally dependent on the reactivity of the crosslinker and can be carried out at temperatures from room temperature to about 180° C., optionally under elevated pressure (see in this connection Houben-Weyl, Methoden der organischen Chemie, 4th Edition, Volume 14/2, page 848). Particularly preferred crosslinkers are peroxides.

The crosslinking of rubbers containing C═C double bonds to form microgels can also be carried out in dispersion or emulsion with the simultaneous partial, or complete, hydrogenation of the C═C double bond by means of hydrazine, as described in U.S. Pat. No. 5,302,696 or U.S. Pat. No. 5,442,009, or optionally other hydrogenating agents, for example organometal hydride complexes.

Enlargement of the particles by agglomeration can optionally be carried out before, during or after the post-crosslinking.

The preparation process used according to the invention always yields incompletely homogeneously crosslinked microgels which can exhibit the above-described advantages.

Rubbers produced by solution polymerisation can also be used as starting materials for the preparation of the microgels. In such cases, solutions of the rubbers in suitable organic solvents are used as starting material.

The desired sizes of the microgels are produced by mixing the rubber solution by means of suitable apparatuses in a liquid medium, preferably in water, optionally with the addition of suitable surface-active auxiliary substances, such as, for example, surfactants, so that a dispersion of the rubber in the appropriate particle size range is obtained. For the crosslinking of the dispersed solution rubbers, the procedure described above for the subsequent crosslinking of emulsion polymerisation products is followed. Suitable crosslinkers are the compounds mentioned above, it being possible for the solvent used for the preparation of the dispersion optionally to be removed prior to the crosslinking, for example by distillation.

As microgels for the preparation of the composition according to the invention there may be used both non-modified microgels, which contain substantially no reactive groups especially at the surface, and microgels modified by functional groups, especially microgels modified at the surface. The latter can be prepared by chemical reaction of the already crosslinked microgels with chemicals that are reactive towards C═C double bonds. These reactive chemicals are especially those compounds by means of which polar groups, such as, for example, aldehyde, hydroxyl, carboxyl, nitrile, etc., and also sulfur-containing groups, such as, for example, mercapto, dithiocarbamate, polysulfide, xanthogenate, thiobenzthiazole and/or dithiophosphoric acid groups and/or saturated dicarboxylic acid groups, can be chemically bonded to the microgels. The same is also true of N,N′-m-phenylenediamine. The purpose of modifying the microgels is to improve the microgel compatibility when the composition according to the invention is used to prepare the subsequent matrix, into which the microgel is incorporated, or the composition according to the invention is used for incorporation into a matrix, in order to achieve a good distribution capacity during preparation as well as good coupling.

Particularly preferred methods of modification are the grafting of the microgels with functional monomers and reaction with low molecular weight agents.

For the grafting of the microgels with functional monomers, there is advantageously used as starting material the aqueous microgel dispersion, which is reacted under the conditions of a free-radical emulsion polymerisation with polar monomers such as acrylic acid, methacrylic acid, itaconic acid, hydroxyethyl (meth)acrylate, hydroxypropyl (meth)acrylate, hydroxybutyl (meth)acrylate, acrylamide, methacrylamide, acrylonitrile, acrolein, N-vinyl-2-pyrrolidone, N-allyl-urea and N-allyl-thiourea, and also secondary amino-(meth)acrylic acid esters such as 2-tert.-butylaminoethyl methacrylate and 2-tert.-butylaminoethylmethacrylamide. In this manner there are obtained microgels having a core/shell morphology, wherein the shell should be highly compatible with the matrix. It is desirable for the monomer used in the modification step to be grafted onto the unmodified microgel as quantitatively as possible. The functional monomers are advantageously metered in before crosslinking of the microgels is complete.

Grafting of the microgels in non-aqueous systems is also conceivable in principle, modification with monomers by means of ionic polymerisation methods also being possible in this manner.

Suitable reagents for the surface modification of the microgels with low molecular weight agents are especially the following: elemental sulfur, hydrogen sulfide and/or alkylpolymercaptans, such as 1,2-dimercaptoethane or 1,6-dimercaptohexane, also dialkyl and dialkylaryl dithiocarbamate, such as the alkali salts of dimethyl dithiocarbamate and/or dibenzyl dithiocarbamate, also alkyl and aryl xanthogenates, such as potassium ethylxanthogenate and sodium isopropylxanthogenate, as well as reaction with the alkali or alkaline earth salts of dibutyldithiophosphoric acid and dioctyldithiophosphoric acid as well as dodecyldithiophosphoric acid. The mentioned reactions can advantageously also be carried out in the presence of sulfur, the sulfur being incorporated with the formation of polysulfide bonds. For the addition of this compound, free-radical initiators such as organic and inorganic peroxides and/or azo initiators can be added.

There comes into consideration also modification of double-bond-containing microgels such as, for example, by ozonolysis as well as by halogenation with chlorine, bromine and iodine. A further reaction of modified microgels, such as, for example, the preparation of hydroxyl-group-modified microgels from epoxidised microgels, is also understood as being the chemical modification of microgels.

In a preferred embodiment, the microgels are modified by hydroxyl groups, especially also at the surface thereof. The hydroxyl group content of the microgels is determined as the hydroxyl number with the dimension mg KOH/g polymer by reaction with acetic anhydride and titration of the acetic acid liberated thereby with KOH according to DIN 53240. The hydroxyl number of the microgels is preferably from 0.1 to 100, more preferably from 0.5 to 50, mg KOH/g polymer.

The amount of modifying agent used is governed by its effectiveness and the demands made in each individual case and is in the range from 0.05 to 30 wt. %, based on the total amount of rubber microgel used, particular preference being given to from 0.5 to 10 wt. %, based on the total amount of rubber gel.

The modification reactions can be carried out at temperatures of from 0 to 180° C., preferably from 20 to 95° C., optionally under a pressure of from 1 to 30 bar. The modifications can be carried out on rubber microgels without a solvent or in the form of their dispersion, it being possible in the latter case to use inert organic solvents or alternatively water as the reaction medium. The modification is particularly preferably carried out in an aqueous dispersion of the crosslinked rubber.

The use of unmodified microgels is especially preferred in the case of compositions according to the invention containing crosslinkable media that lead to the formation of non-polar thermoplastic materials (A), such as, for example, polypropylene, polyethylene and block copolymers based on styrene, butadiene and isoprene (SBR, SIR) and hydrogenated isoprene-styrene block copolymers (SEBS), and conventional TPE-Os and TPE-Vs, etc.

The use of modified microgels is especially preferred in the case of compositions according to the invention containing crosslinkable media that lead to the formation of polar thermoplastic materials (A), such as, for example, PA, TPE-A, PU, TPE-U, PC, PET, PBT, POM, PMMA, PVC, ABS, PTFE, PVDF, etc.

The mean diameter of the prepared microgels can be adjusted with high accuracy, for example, to 0.1 micrometre (100 nm)±0.01 micrometre (10 nm), so that, for example, a particle size distribution is achieved in which at least 75% of all the microgel particles are from 0.095 micrometre to 0.105 micrometre in size. Other mean diameters of the microgels, especially in the range from 5 to 500 nm, can be produced with the same accuracy (at least 75 wt. % of all the particles are located around the maximum of the integrated particle size distribution curve (determined by light scattering) in a range of ±10% above and below the maximum) and used. As a result, the morphology of the microgels dispersed in the composition according to the invention can be adjusted virtually “point accurately” and hence the properties of the composition according to the invention and of the plastics, for example, produced therefrom can be adjusted.

The microgels so prepared, preferably based on BR, SBR, NBR, SNBR or acrylonitrile or ABR, can be worked up, for example, by concentration by evaporation, coagulation, by co-coagulation with a further latex polymer, by freeze coagulation (see U.S. Pat. No. 2,187,146) or by spray-drying. In the case of working up by spray-drying, commercially available flow auxiliaries, such as, for example, CaCO₃ or silica, can also be added.

In a preferred embodiment of the composition according to the invention, the microgel (B) is based on rubber.

In a preferred embodiment of the composition according to the invention, the microgel (B) has been modified by functional groups reactive towards C═C double bonds.

In a preferred embodiment, the microgel (B) has a swelling index in toluene at 23° C. of from 1 to 15.

The composition according to the invention preferably has a viscosity of from 25 mPas to 5,000,000 mPas, more preferably from 200 mPas to 3,000,000 mPas, at a speed of 5 s⁻¹ in a cone/plate viscometer according to DIN 53018 at 20° C.

Organic Crosslinkable Medium (A)

The composition according to the invention comprises at least one organic medium (A) that has a viscosity at a temperature of 120° C. of less than 30,000 mPas, preferably less than 10,000 mPas, more preferably less than 1000 mPas, yet more preferably less than 750 mPas and even more preferably less than 500 mPas.

The viscosity of the crosslinkable organic medium (A) is determined at a speed of 5 s⁻¹ by means of a cone/plate measuring system according to DIN 53018 at 120° C.

Such a medium is liquid to solid, preferably liquid or flowable, at room temperature (20° C.).

Organic medium within the scope of the invention means that the medium contains at least one carbon atom.

The crosslinkable organic media (A) are preferably those that are crosslinkable via functional groups containing hetero atoms or via C═C groups.

They generally have the above-mentioned viscosities, but it is also possible according to the invention to use crosslinkable media having higher viscosities and to mix them with further crosslinkable media of lower viscosity in order to establish the above-mentioned viscosities.

There are preferably used as component (A) crosslinkable media that are liquid at room temperature (20° C.) and that are generally cured to form plastics by reaction with a further component (C), for example by free-radical, especially peroxidic, crosslinking in the presence of free-radical initiators or by UV radiation, by polyaddition or polycondensation, as described hereinbelow.

The choice of a component (C) suitable for crosslinking for a suitable crosslinkable organic medium (A) is known per se to the person skilled in the art, and reference can be made to the relevant specialist literature.

The liquid crosslinkable organic media (A) suitable for the preparation of the compositions according to the invention are, for example, polyols based on polyesters, polyethers or polyether polyesters, and epoxy resins, unsaturated polyester resins and acrylate resins. The resins or resin mixtures described herein and their curing agents or curing agent mixtures are preferably characterised in that one component has a functionality close to 2.0 and the other component has a functionality of preferably from 1.5 to 2.5, more preferably from 2 to 2.5, so that polymers that are linear or weakly branched, but not chemically crosslinked, are obtained. (See G. W. Becker, D. Braun, Kunststoff-Handbuch Vol. 10, “Duroplaste”, Carl Hanser Verlag, Munich, Vienna, 1988, p. 1ff.) It is also possible to use additions of mono- and multi-functional components having a functionality of from 1 to about 4, preferably from 1 to 3, total functionalities of approximately from 1.5 to 2.5 being obtained.

Polyester polyols are prepared by condensation of dicarboxylic acids with excess amounts of diols or polyols or are based on caprolactones. Described, for example, by Walter Krauβ in Kittel, Lehrbuch der Lacke und Beschichtungen, S. Hirzel Verlag Stuttgart•Leipzig, Vol. 2 (1998) 205ff.

There are used as polyether polyols preferably those based on propylene oxide and/or ethylene oxide. Described, for example, by Walter Krauβ in Kittel, Lehrbuch der Lacke und Beschichtungen, S. Hirzel Verlag Stuttgart•Leipzig, Vol. 2 (1998) 205ff. Polyoxytetra-methylene glycols are also used. Described, for example, by Walter Krauβ in Kittel, Lehrbuch der Lacke und Beschichtungen, S. Hirzel Verlag Stuttgart•Leipzig, Vol. 2 (1998) 205ff.

The addition of alkylene oxides to di- or poly-amines leads to nitrogen-containing basic polyethers. Described, for example, by Walter Krauβ in Kittel, Lehrbuch der Lacke und Beschichtungen, S. Hirzel Verlag Stuttgart•Leipzig, Vol. 2 (1998) 205ff.

The mentioned polyols are preferably reacted with aromatic isocyanates, such as TDI (toluoylene diisocyanate) or MDI (methylene-diphenyl diisocyanate), in some cases also with NDI (naphthalene-1,5-diisocyanate) or TODI (3,3′-dimethyl-4,4′-diisocyanato-biphenyl) and their derivatives, aromatic polyisocyanates on the same basis or aliphatic isocyanates (HDI, IPDI, H₁₂MDI (4,4′-dicyclohexylmethane diisocyanate), HTDI (methylcyclohexyl diisocyanate), XDI (xylylene diisocyanate), TMDI (trimethylhexamethylene diisocyanate), DMI (dimeryl diisocyanate) or aliphatic polyisocyanates on the same basis, such as the trimer of HDI (hexamethylene diisocyanate) or of IPDI (isophorone diisocyanate). Described, for example, by Walter Krauβ in Kittel, Lehrbuch der Lacke und Beschichtungen, S. Hirzel Verlag Stuttgart•Leipzig, Vol. 2 (1998) 197ff.

Epoxy resins are cured with amine curing agents, amine adducts, amines or polyamines or acid anhydrides. Epoxy resins are prepared by reaction of phenols or alcohols with epichlorohydrin. The most important resin, also in terms of quantity, is the diglycidyl ether of bisphenol A in addition to the diglycidyl ether of bisphenol F. Described, for example, by Walter Krauβ in Kittel, Lehrbuch der Lacke und Beschichtungen, S. Hirzel Verlag Stuttgart•Leipzig, Vol. 2 (1998) 269ff. Further epoxy resins are the diluents, such as hexane diglycidyl ether, the epoxide novolaks, the glycidyl esters, the glycidyl amines, the glycidyl isocyanurates and the cycloaliphatic epoxides.

Important amines are the aliphatic and cycloaliphatic amines, such as diethylenetriamine (DETA), triethylenetetramine (TETA), 3,3′,5-trimethylhexamethylenediamine (TMD), isophoronediamine (IPD), m-xylylenediamine (MXDA), the aromatic amines, such as methylenedianiline (MDA), 4,4′-diaminodiphenylsulfone (DDS), amine adducts, such as, for example, of TMD and the diglycidyl ether of bisphenol A and DETA-phenol-Mannich base, polyaminoamides such as are produced during the formation of amides from polyethylenediamines and monomer and dimer fatty acids, and dicyandiamide. Described, for example, by Walter Krauβ in Kittel, Lehrbuch der Lacke und Beschichtungen, S. Hirzel Verlag Stuttgart•Leipzig, Vol. 2 (1998) 272ff. Amines with suitable low functionality are the corresponding alkylated types.

Cyclic acid anhydrides are, for example, phthalic anhydride (PSA) and hexahydrophthalic anhydride. Described, for example, by Walter Krauβ in Kittel, Lehrbuch der Lacke und Beschichtungen, S. Hirzel Verlag Stuttgart•Leipzig, Vol. 2 (1998) 272ff.

Unsaturated polyester resins are linear, soluble polyconden-sation products of mainly maleic or fumaric acid and dihydric alcohols, which can be dissolved in a monomer capable of copolymerisation, mostly styrene, and are polymerised by addition of peroxides. Described, for example, by Walter Krauβ in Kittel, Lehrbuch der Lacke und Beschichtungen, S. Hirzel Verlag Stuttgart•Leipzig, Vol. 2 (1998) 473ff.

As acids there may be used in the UP resins adipic acid, phthalic acid, phthalic anhydride, tetrahydrophthalic acid, isophthalic acid, terephthalic acid, tetrachlorophthalic acid, tetrabromophthalic acid, hetic acid and endo-methylene-tetrahydrophthalic anhydride. As diols for UP resins there are mainly used 1,2- and 1,3-propanediol, ethylene glycol, diethylene glycol, dipropylene glycol and monoallyl ethers of glycerol and trimethylolpropane.

Monomers that are used in addition to other polymerisable monomers are, for example, styrene, alpha-methylstyrene, methyl acrylate, methyl methacrylate and vinyl acetate. Described, for example, by Walter Krauβ in Kittel, Lehrbuch der Lacke und Beschichtungen, S. Hirzel Verlag Stuttgart•Leipzig, Vol. 2 (1998) 473ff.

Crosslinking of the crosslinkable composition according to the invention is preferably carried out peroxidically or by UV light or electron beams. Described, for example, by Walter Krauβ in Kittel, Lehrbuch der Lacke und Beschichtungen, S. Hirzel Verlag Stuttgart•Leipzig, Vol. 2 (1998) 473ff.

Similar to the unsaturated polyester resins are the vinyl esters, as are produced, for example, by Dow—Derakane and Derakane Momentum.

The liquid crosslinkable organic media (A) suitable for the preparation of the compositions according to the invention also include, for example: multifunctional alcohols, such as difunctional alcohols, such as ethylene glycol, propanediol, butanediol, hexanediol, octanediol, polyether polyols, such as diethylene glycol, dipropylene glycol, polyalkylene oxide diols, such as polyethylene and/or propylene oxide diols, polyhexamethylene carbonate diols, multifunctional alcohols, such as glycerol, trimethylolpropane, etc., multifunctional carboxylic acids, cyclic carboxylic acid anhydrides, multifunctional isocyanates, such as TDI (toluoylene diisocyanate), MDI (methylenediphenyl diisocyanate), NDI (napthalene-1,5-diisocyanate), TODI (3,3′-dimethyl-4,4′-diisocyanato-biphenyl) and their derivatives, HDI, IPDI, H₁₂MDI (4,4′-dicyclohexylmethane diisocyanate), HTDI (methylcyclohexyl diisocyanate), XDI (xylylene diisocyanate), TMDI (trimethylhexamethylene diisocyanate), DMI (dimeryl diisocyanate) or aliphatic polyisocyanates on the same basis, such as the trimer of HDI (hexamethylene diisocyanate) or of IPDI (isophorone diisocyanate), polyisocyanate prepolymers, especially oligomerised diisocyanates, masked polyisocyanates, multifunctional amines, such as those mentioned above, such as ethylenediamine, tetramethylenediamine, hexamethylenediamine, trimethylhexamethylenediamine, isophoronediamine, dodecyldiamine, lactams, such as caprolactam, butyrolactam, lactones, such as gamma-butyrolactone, caprolactone, cyclic ethers, such as tetrahydrofuran, unsaturated hydrocarbons, ethylene, propylene, butadiene, styrene, methylstyrene, acrylonitrile, vinyl esters, such as vinyl acetate, vinyl propionate, vinyl butyrate, cyclopentene, norbornene, dicyclopentene, etc.

Further possible crosslinkable media are methyl methacrylate, alkyl methacrylates, alkyl acrylates or mixtures with comonomers such as methyl acrylates or acrylates, which are cured by peroxides or UV radiation/electron beams.

Particularly preferred crosslinkable organic media are polyols, polyether polyols, polyether diols, polyester diols, polyether ester diols, polyhexamethylene carbonate diols, diisocyanates, polyisocyanate prepolymers.

It is also possible to mix the polyfunctional compounds conventionally referred to as crosslinkers (C) for a polymer system, as the crosslinkable medium within the scope of the invention, with the microgels and to react the resulting composition with the appropriate component that is to be crosslinked.

In principle, it must be ensured that the microgels can be reactive towards the crosslinkable medium.

Polymers or copolymers of the mentioned monomers may also be dissolved in the above-described materials.

For curing by means of UV radiation/electron beams there are used especially monomers such as, for example, 2-ethylhexyl acrylate (EHA), stearyl acrylate and polyether acrylates, such as, for example, polyethylene glycol diacrylate 400 (PEG400DA), polyester acrylates, which are prepared, for example, from polyester polyols or corresponding polyol/polycarboxylic acid mixtures by esterification with acrylic acid, urethane acrylates and acrylated polyacrylates. Described, for example, by Walter Krauβ in Kittel, Lehrbuch der Lacke und Beschichtungen, S. Hirzel Verlag Stuttgart•Leipzig, Vol. 2 (1998) 416ff.

The invention relates further to the use of the composition according to the invention in the preparation of microgel-containing polymers, as explained hereinbefore.

If there are used as the crosslinkable component (A) those components that would result in the formation of thermoplastic polymers, it is found, wholly surprisingly, that microgel-containing polymers that behave like thermoplastic elastomers are obtained. The invention accordingly relates especially also to thermoplastic elastomers obtained by polymerisation or crosslinking of the compositions according to the invention comprising component (A).

The invention further relates also to polymers or crosslinking products, especially thermoplastic elastomers, that are obtained by crosslinking or polymerisation of the compositions comprising the microgels and the crosslinkable component (A), and to moulded bodies and coatings produced therefrom by conventional processes.

In comparison with the incorporation of microgels into polymers by extrusion processes, as described, for example, in DE 10345043, which is as yet unpublished and has the same filing date, or the so-called in situ process, in which the rubber particles are crosslinked during the mixing or dispersing process (e.g. U.S. Pat. No. 5,013,793), the compositions according to the invention allow microgels to be incorporated into polymers in a particularly simple and uniform manner, with the result that the polymers obtained surprisingly possess improved properties.

The invention accordingly relates also to a process for the preparation of microgel-containing polymer compositions, which comprises mixing at least one crosslinkable organic medium (A) that has a viscosity of less than 30,000 mPas at a temperature of 120° C., and at least one microgel (B) that has not been crosslinked by means of high-energy radiation, then adding a crosslinker (C) for the crosslinkable medium (A) and subsequently crosslinking or polymerising the composition. By means of this process it is possible to obtain so-called thermoplastic elastomers, that is to say polymers which, owing to the presence of the microgel phase, behave like elastomers at low temperatures (such as room temperature) but at higher temperatures can be processed like thermoplastics. In a preferred embodiment of the above process, the crosslinkable organic medium (A) is a polyol, more preferably a diol, or a mixture thereof and the crosslinker (C) is a polyisocyanate, preferably a diisocyanate, or a mixture thereof. Monofunctional so-called chain terminators may optionally also be present, as is known to the person skilled in the art.

The composition according to the invention preferably comprises from 1 to 60 wt. %, more preferably from 3 to 40 wt. %, yet more preferably from 5 to 25 wt. %, of the microgel (B), based on the total amount of the composition.

The composition according to the invention further comprises preferably from 10 to 99 wt. %, more preferably from 30 to 95 wt. %, yet more preferably from 40 to 90 wt. %, even more preferably from 50 to 85 wt. %, of the crosslinkable organic medium (A).

The composition according to the invention preferably comprises the crosslinkable organic medium (A) and the microgel (B) and optionally the further components mentioned hereinbelow. The presence of water is not preferred, the compositions according to the invention preferably contain less than 0.8 wt. %, more preferably less than 0.5 wt. %, water. The presence of water is most preferably excluded (<0.1 wt. %).

In a further embodiment, the composition according to the invention may additionally comprise, for example, non-crosslinkable organic media, such as, especially, organic solvents, saturated or aromatic hydrocarbons, polyether oils, ester oils, polyether ester oils, phosphoric acid esters, silicon-containing oils and halogenated hydrocarbons or combinations thereof, fillers, pigments, catalysts and additives, such as dispersing aids, de-aerators, flow agents, auxiliary substances for the wetting of substrates, adhesion promoters for controlling substrate wetting, for controlling conductivity, auxiliary substances for controlling colour stability, gloss and floating.

The mentioned additives can especially be incorporated into the compositions according to the invention particularly uniformly, which in turn leads to an improvement in the polymer compositions prepared therefrom.

Particularly suitable pigments and fillers for the preparation of the compositions according to the invention comprising the crosslinkable medium (A), and of microgel-containing plastics produced therefrom, are, for example: inorganic and organic pigments, silicate-like fillers such as kaolin, talcum, carbonates such as calcium carbonate and dolomite, barium sulfate, metal oxides such as zinc oxide, calcium oxide, magnesium oxide, aluminium oxide, highly dispersed silicas (precipitated silicas and silicas produced by thermal means), metal hydroxides such as aluminium hydroxide and magnesium hydroxide, glass fibres and glass fibre products (laths, threads or glass micro-spheres), carbon fibres, thermoplastic fibres (polyamide, polyester, aramid), rubber gels based on polychloroprene and/or polybutadiene, and also any other gel particles described above having a high degree of crosslinking and a particle size of from 5 to 1000 nm.

The mentioned fillers can be used alone or in a mixture. In a particularly preferred embodiment of the process, from 1 to 30 parts by weight of rubber gel (B), optionally together with from 0.1 to 40 parts by weight of fillers, and from 30 to 99 parts by weight of liquid crosslinkable medium (A) are used to prepare the compositions according to the invention.

The compositions according to the invention can comprise further auxiliary substances, such as crosslinkers, reaction accelerators, anti-ageing agents, heat stabilisers, light stabilisers, anti-ozonants, plasticisers, tackifiers, blowing agents, colourings, waxes, extenders, organic acids, retarding agents and also filler activators, such as, for example, trimethoxysilane, polyethylene glycol, solvents, such as those mentioned above, or others which are known in the described industries.

The auxiliary substances are used in conventional amounts, which are governed inter alia by the intended use. Conventional amounts are, for example, amounts of from 0.1 to 80 wt. %, preferably from 0.1 to 50 wt. %, based on the amount of liquid crosslinkable medium (A) used.

In a preferred embodiment, the composition according to the invention is prepared by mixing at least one crosslinkable organic medium (A) that has a viscosity of less than 30,000 mPas at a temperature of 120° C., and at least one dry microgel powder (B) (preferably less than 1 wt. %, more preferably less than 0.5 wt. % volatile portions (no microgel latices are used when mixing components (A) and (B)) that has not been crosslinked by means of high-energy radiation, by means of a homogeniser, a bead mill, a three-roller mill, a single- or multi-shaft barrel extruder, a kneader and/or a dissolver, preferably by means of a homogeniser, a bead mill or a three-roller mill.

With regard to the viscosity of the composition, kneaders, in which preferably only very highly viscous (almost solid to solid) compositions can be used, are the most limited, that is to say they can be used only in special cases.

Disadvantages of bead mills are the comparatively limited viscosity range (tends to be preferred for thin compositions), the high outlay in terms of cleaning, the expensive product change-over of the compositions that can be used, and wear of the beads and the grinding apparatus.

Homogenisation of the compositions according to the invention is particularly preferably carried out by means of a homogeniser or a three-roller mill. Disadvantages of three-roller mills are the comparatively limited viscosity range (tendency towards very thick compositions), the low throughput and the fact that the procedure is not closed (poor working protection).

Homogenisation of the compositions according to the invention is very preferably carried out by means of a homogeniser. The homogeniser allows thin and thick compositions to be processed with a high throughput (high flexibility). Product change-over is possible relatively quickly and without difficulty.

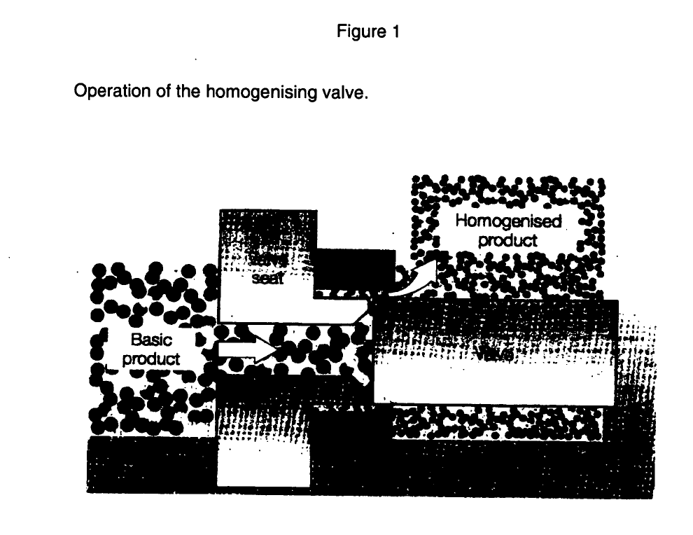

The dispersion of the microgels (B) in the liquid medium (A) takes place in the homogeniser in the homogenising valve (see FIG. 1).

In the process used according to the invention, agglomerates are comminuted into aggregates and/or primary particles. Agglomerates are physically separable units which undergo no change in primary particle size during dispersion.

FIG. 1 shows the operation of the homogenising valve.

The product to be homogenised enters the homogenising valve at slow speed and is accelerated to high speeds in the homogenising gap. Dispersion takes place downstream of the gap, principally as a result of turbulence and cavitation. See William D. Pandolfe, Peder Baekgaard, Marketing Bulletin of APV Homogeniser Group—“High-pressure homogenisers processes, product and applications”.

The temperature of the composition according to the invention on introduction into the homogeniser is advantageously from −40 to 140° C., preferably from 20 to 80° C.

The composition according to the invention that is to be homogenised is preferably homogenised in the device at a pressure of from 20 to 4000 bar, preferably from 100 to 4000 bar, preferably from 200 to 4000 bar, preferably from 200 to 2000 bar, very preferably from 500 to 1500 bar. The number of passes is governed by the desired dispersion quality and can vary from one to 40, preferably from one to 20, more preferably from one to four passes.

The compositions prepared according to the invention have a particularly fine particle distribution, which is achieved especially with the homogeniser and is extremely advantageous also in respect of the flexibility of the process with regard to varying viscosities of the liquid media and of the resulting compositions and necessary temperatures as well as the dispersion quality (Example 4).

The invention relates further to the use of the compositions according to the invention in the production of moulded articles, and to moulded articles obtainable from the compositions according to the invention. Examples of such moulded articles include: plug-type connectors, damping elements, especially vibration damping elements and shock absorbers, acoustic damping elements, profiles, films, especially damping films, foot mats, clothing, especially shoe insoles, shoes, especially ski shoes, shoe soles, electronic components, casings for electronic components, tools, decorative mouldings, composite materials, mouldings for motor vehicles, etc.

The moulded articles according to the invention can be produced from the compositions according to the invention by conventional processing methods, such as by casting and injection moulding by means of 2K installations, melt extrusion, calandering, IM, CM and RIM, etc.

The invention is explained in greater detail with reference to the following Examples. The invention is of course not limited to these Examples.

### EXAMPLES

### Example 1

### Hydroxyl-Group-Modified SBR Gels (RFL 403A) in Desmophen 1150

In the Example described below it is shown that a microgel composition according to the invention having particle diameters of 220 nm and below can be prepared using a hydroxyl-group-modified SBR-based microgel by means of a homogeniser by application of from 900 to 1000 bar.

The composition of the microgel composition according to the invention is indicated in the table below:

| | | |
|---|---|---|
| 1. | Desmophen 1150 | 79.7 |
| 2. | RFL 403 A | 20 |
| 3. | Tego Airex 980 | 0.3 |
| | Total | 100 |

Desmophen 1150 is a branched polyalcohol having ester and ether groups from Bayer AG for the preparation of viscoelastic coatings.

Tego Airex 980, an organically modified polysiloxane, is a de-aerator from Tego Chemie Service GmbH.

RFL 403A is a crosslinked, surface-modified SBR-based rubber gel from RheinChemie Rheinau GmbH.

RFL 403 A consists of 70 wt. % butadiene, 22 wt. % styrene, 5 wt. % ethylene glycol dimethacrylate (EGDMA) and 3 wt. % hydroxyethyl methacrylate (HEMA).

Preparation Example 1 for RFL 403A

Microgel based on hydroxyl-modified SBR, prepared by direct emulsion polymerisation using the crosslinking monomer ethylene glycol dimethacrylate.

350 g of the Na salt of a long-chained alkylsulfonic acid (368.4 g of Mersolat K30/95 from Bayer AG) and 27 g of the Na salt of methylene-bridged naphthalenesulfonic acid (Baykanol PQ from Bayer AG) are dissolved in 2.03 kg of water and placed in a 5 litre autoclave. The autoclave is evacuated three times and charged with nitrogen. 872 g of butadiene, 274 g of styrene, 69 g of ethylene glycol dimethacrylate (90%), 38.5 g of hydroxyethyl methacrylate (96%) are then added. The reaction mixture is heated to 30° C., with stirring. An aqueous solution consisting of 25 g of water, 180 mg of ethylenediaminetetraacetic acid (Merck-Schuchardt), 150 mg of iron(II) sulfate*7H₂O, 400 mg of Rongalit C (Merck-Schuchardt) and 500 mg of trisodium phosphate*12H₂O is then metered in. The reaction is started by addition of an aqueous solution of 350 mg of p-menthane hydroperoxide (Trigonox NT 50 from Akzo-Degussa) and 25 mg of Mersolat K 30/95, dissolved in 25 g of water. After a reaction time of 2.5 hours, the reaction temperature is raised to 40° C. After a reaction time of 5 hours, re-activation is carried out using an aqueous solution consisting of 25 g of water in which 25 g of Mersolat K30/95 and 350 mg of p-menthane hydroperoxide (Trigonox NT 50) are dissolved. When a polymerisation conversion of 95-99% is achieved, the polymerisation is stopped by addition of an aqueous solution of 2.5 g of diethylhydroxylamine, dissolved in 50 g of water. Unconverted monomers are then removed from the latex by stripping with steam. The latex is filtered, and stabiliser is added as in Example 2 of U.S. Pat. No. 6,399,706, followed by coagulation and drying.

RFL 403B consists of 80 wt. % styrene, 12 wt. % butadiene, 5 wt. % ethylene glycol dimethacrylate (EGDMA) and 3 wt. % hydroxyethyl methacrylate (HEMA). RFL 403 B is prepared analogously to RFL 403 A, 996 g of styrene, 149 g of butadiene, 62 g of ethylene glycol dimethacrylate and 37 g of hydroxyethyl methacrylate being used in the polymerisation.

RFL 403A and RFL 403B were obtained from the latex by spray drying.

For the preparation of the composition according to the invention, Desmophen 1150 was placed in a vessel, and RFL 403A and Tego Airex 980 were added with stirring by means of a dissolver. The mixture was left to stand for one day and was then processed further by means of a homogeniser.

The composition according to the invention was introduced into the homogeniser at room temperature and was passed through the homogeniser 19 times in batch operation at from 900 to 1000 bar. The composition warms to about 40° C. during the first pass and to about 70° C. during the second pass. It was ensured that the temperature of the composition does not exceed 120° C., which was achieved by cooling in a refrigerator.

The mean particle diameter of the microgel particles was measured using a LS 230 Beckman-Coulter device by means of laser-light scattering. The d50 value of the microgel particles is 112 μm before homogenisation and 220 nm after homogenisation.

The (theoretical) primary particle diameter of 70 nm is achieved in 10% of the particles in the composition. It should be noted that static laser-light scattering, contrary to an ultracentrifuge, does not give absolute values. The values tend to be too high in the case of this composition.

The LS 230 Beckman-Coulter device uses a static process, laser diffractometry (LD), as the measuring method. The measuring range can be broadened from 2000 μm down to 40 nm by the use of PIDS technology (PIDS: polarization intensity differential scattering).

### Example 2

### Hydroxyl-Group-Modified SBR Gels (RFL 403A) in Desmophen RC-PUR KE 8306

In the Example described below it is shown that compositions according to the invention containing particles or particle agglomerates having particle diameters principally in the range from 50 nm to 500 nm, with a mean particle diameter of about 250 nm, can be prepared using hydroxyl-group-modified SBR-based microgels in a homogeniser by application of from 900 to 1000 bar.

The composition of the microgel paste is indicated in the table below:

| | | |
|---|---|---|
| 1. | RC-PUR KE 8306 | 93.3 |
| 2. | Byk-LP X 6331 | 0.2 |
| 3. | RFL 403A | 6.5 |
| | Total | 100 |

RC-PUR KE 8306 is an activated polyol blend for the preparation of PUR by the cold-casting process from RheinChemie Rheinau GmbH.

The crosslinking component used is RC-DUR 120, an aromatic polyisocyanate from RheinChemie Rheinau GmbH.

Byk-LP X 6331 is a de-aerator for PU systems from Byk-Chemie GmbH.

RFL 403A is a crosslinked, surface-modified SBR-based rubber gel from Rhein Chemie Rheinau GmbH. RFL 403 B has been described above.

For the preparation of the composition according to the invention, RC-PUR KE 8306 was placed in a vessel and Byk-LP X 6331 and RFL 403A or RFL 403 B were added, with stirring. The mixture was left to stand for at least one day and was then processed further by means of a homogeniser.

The composition according to the invention was introduced into the homogeniser at room temperature and was passed through the homogeniser twice in batch operation at from 900 to 1000 bar. The microgel paste warms to about 40° C. during the first pass and to about 70° C. during the second pass.

Thereafter, the composition according to the invention was reacted with RC-DUR 120 to form a polymer belonging to the class of the cold-cast elastomers (PUR-E).

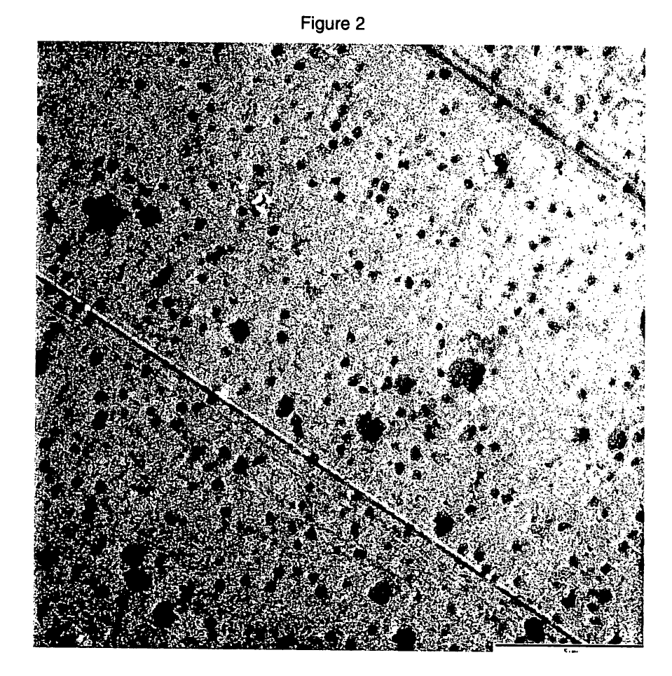

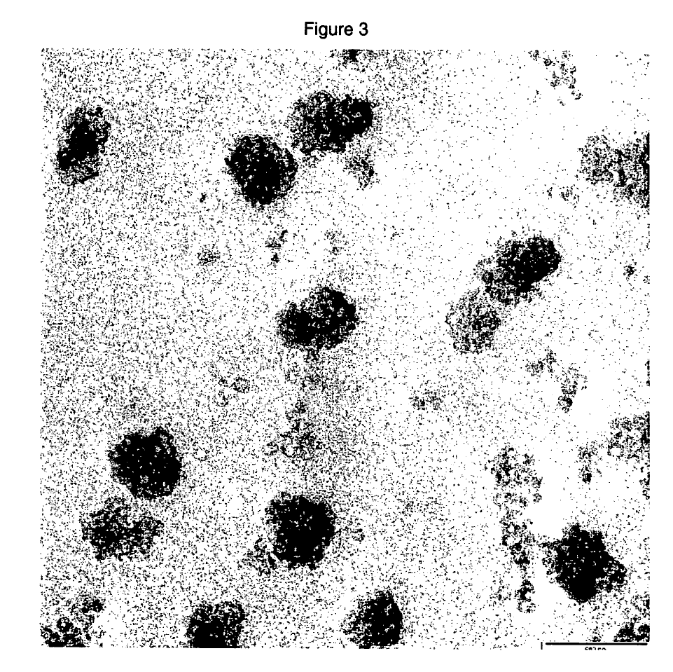

The particle size of the rubber gel particles and agglomerates, and the structure of the rubber gel agglomerates in the resulting PUR-E, were studied by means of TEM images (see FIGS. 2 and 3).

Owing to the particularly homogeneous distribution of the microgels in the polyol component of RC-PUR KE 8306, particular properties, such as improved tear strength and improved impact strength, are achieved (see table below).

| | MG content | Shore D | Tear strength | Impact strength |
|---|---|---|---|---|
| | [%] | [-] | [N/mm] | [kJ/m²] |
| KE 8306 | 0¹⁾ | 82 | 29 | 48 |
| KE 8306 | 5¹⁾ | 82 | 47 | 62 |
| KE 8306 | 10¹⁾ | 81 | 51 | 65 |
| KE 8306 | 10²⁾ | 83 | 43 | — |

¹⁾RFL 403 A
²⁾RFL 403 B

The Shore D hardness was measured according to DIN 53505 and the tear strength according to DIN 53515 at room temperature (about 23° C.). The Charpy impact strength was measured according to DIN EN ISO 179 at 22° C. The test rods used for testing had the following dimensions: about 15.3 cm×1.5 cm×1 cm.

Determination of Morphology

The morphology is determined by means of transmission electron microscopy (TEM) images.

TEM:

Preparation of samples for transmission electronmicroscopic tests.

Cryo-ultramicrotomy

Procedure:

Under cryo conditions, thin sections having a thickness of about 70 nm were prepared by means of a diamond blade. In order to improve the contrast, contrasting with OsO₄ was carried out for some sections.

The thin sections were transferred to copper nets, dried and first assessed in the TEM over a large area. Then, with 80 kV acceleration voltage, with suitable magnification, an area of 833.7 nm*828.8 nm of a characteristic image section was stored by means of digital software for documentation purposes and evaluated.

FIG. 2 shows a TEM image of a PUR system (E), prepared from a composition according to the invention and RC-DUR 120; scale 5 μm (5000 times).

FIG. 3 shows a TEM image of a PUR system (E) prepared from a composition according to the invention and RC-DUR 120; scale 500 nm (50,000 times).

The TEM images show that particles or particle agglomerates having particle diameters principally in the range from 50 nm to 500 nm, with a mean particle diameter of about 250 nm, are present, whereas, according to experience, the mean particle diameter after incorporation of the microgels by means of a dissolver is about 120 nm (RFL 403A).

The particle sizes determined directly in this Example support the values determined indirectly in Example 1 in the rubber gel paste (D) by means of laser diffractometry (LD).

Owing to the particularly fine distribution of the microgels in the plastics matrix, improved properties, such as higher tear strengths and higher impact strengths, are achieved.

### Example 3

### Hydroxyl-Group-Modified SBR Gels (RFL 403B or RFL 403A) in RC-Phen E 123

In the Example described below it is shown that, using hydroxyl-group-modified SBR-based gels, compositions according to the invention that have been dispersed using a homogeniser exhibit improved properties after curing, which properties are due to the nanoparticles.

The composition of a microgel paste containing 19% microgel is indicated by way of example in the table below:

| | | |
|---|---|---|
| 1. | RC-Phen 123 | 75.127 |
| 2. | Activator mixture | 0.0613 |
| 2. | Byk-LP X 6331 | 0.283 |
| 3. | RFL 403B | 18.868 |
| | T-Paste | 5.660 |
| | Total | 100 |

The blends used differ in respect of the amount and type of microgel added. The activator mixture consists mainly of RC-PUR activator 105E and 50 wt. % Mesamoll (Bayer AG).

RC-Phen E 123 is an unactivated polyol blend for the preparation of PUR by the cold-casting process from RheinChemie Rheinau GmbH.

The crosslinking component used is RC-DUR 110, an aromatic polyisocyanate from RheinChemie Rheinau GmbH.

RC-PUR activator 105E is a PU additive from RheinChemie Rheinau GmbH.

Byk-LP X 6331 is a de-aerator for PU systems from Byk-Chemie GmbH.

RFL 403A is a crosslinked, surface-modified SBR-based rubber gel from RheinChemie Rheinau GmbH.

T-Paste is a commercial filler-containing product from UOP. For the preparation of the composition according to the invention, RC-Phen E 123 was placed in a vessel, and the activator mixture, Byk-LP X 6331, RFL 403A and T-Paste were added with stirring by means of a dissolver. The mixture was left to stand for at least one day and was then processed further by means of a homogeniser.

The composition according to the invention was introduced into the homogeniser at room temperature and was passed through the homogeniser twice in batch operation at from 900 to 1000 bar. The microgel paste warms to about 40° C. during the first pass and to about 70° C. during the second pass.

Thereafter, the composition according to the invention was reacted with RC-DUR 110 to form a polymer belonging to the class of the cold-cast elastomers.

By the addition of the microgels to the polyol component of RC-Phen E 123, particular properties such as improved tear strength, reinforcement, greater hardness and higher rebound resilience are achieved (see tables and figures below).

The Shore A hardness was measured according to DIN 53505, the rebound resilience according to DIN 53512, the tensile properties according to EN ISO 527-1 (standard rods S2 prepared according to DIN 53504) and the tear strength according to DIN 53515 at room temperature (RT) (about 23° C.).

TABLE
Stress^{σ}^{ₓ} at 50%, 100% and 200% elongation for the system
“RC-Phen 123 - RFL 403A - RC DUR 110”; RT
(manual processing).

| Microgel | Stress | Stress | Stress | |
|---|---|---|---|---|
| content | σ₅₀ | σ₁₀₀ | σ₂₀₀ | |
| [%] | [MPa] | [MPa] | [MPa] | Notes |
| 0 | 0.7 | 1.0 | 1.5 | dispersed |
| 0 | 0.7 | 1.0 | 1.6 | with 2.2% Omyalite 90 |
| 3.1 | 0.7 | 1.1 | 1.7 | dispersed |
| 6.1 | 0.9 | 1.3 | 2.1 | dispersed |
| 12 | 0.7 | 1.2 | 2.0 | dispersed |

The reinforcing effect of RFL 403A is clear from the tensions σₓ at 200% elongation.

TABLE
Hardness, rebound resilience and tear strength for the system RC-
Phen 123 - RFL 403A - RC DUR 110; RT (manual processing).

| Microgel | | Rebound resilience | |
|---|---|---|---|
| content | Hardness | at 20° C. | |
| [%] | [ShA] | [%] | Notes |
| 0 | 46 | 49 | dispersed |
| 0 | 47 | 50 | with 2.2% |
| | | | Omyalite 90 |
| 3.1 | 50 | 52 | dispersed |
| 6.1 | 52 | 50 | dispersed |
| 12 | 49 | 51 | dispersed |

The increase in the rebound resilience is interesting, even though the system RC-Phen E 123 is already highly resilient; however, the increase is small.

TABLE
Stress^{σ}^{ₓ} at 50%, 100%, 200% and 300% elongation for the system
“RC-Phen 123 - RFL 403 B - RC DUR110”; RT (processing by
machine).

| Microgel | Stress | Stress | Stress | Stress | | Stress at |
|---|---|---|---|---|---|---|
| content | σ₅₀ | σ₁₀₀ | σ₂₀₀ | σ₃₀₀ | | break σ_{B} |
| [%] | [MPa] | [MPa] | [MPa] | [MPa] | σ_{300/}σ₁₀₀ | [MPa] |
| 0 | 0.7 | 1.1 | 1.7 | 2.5 | 2.3 | 4.6 |
| 2.5 | 0.8 | 1.2 | 2.0 | 3.1 | 2.6 | 6.8 |
| 5 | 0.9 | 1.4 | 2.3 | 3.6 | 2.6 | 6.3 |
| 7.5 | 0.9 | 1.4 | 2.4 | 3.8 | 2.7 | 7.6 |
| 20 | 1.5 | 2.3 | 4.1 | 6.5 | 2.8 | 10.1 |
| 25 | 2.2 | 3.4 | 6 | 9.7 | 2.9 | 10.3 |

The reinforcing effect of RFL 403B is very greatly pronounced at all elongations.

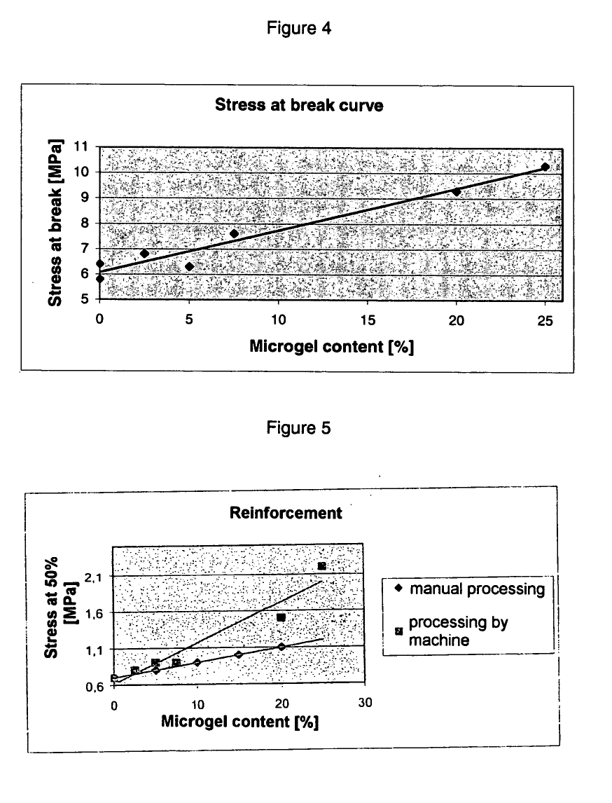

FIG. 4 shows the stress at break curve for the system “RC-Phen 123-RFL 403B-RC-DUR 110”; RT (processing by machine).

FIG. 5 shows the reinforcement at 50% elongation for the system “RC-Phen 123-RFL 403 B-RC DUR 110”; RT.

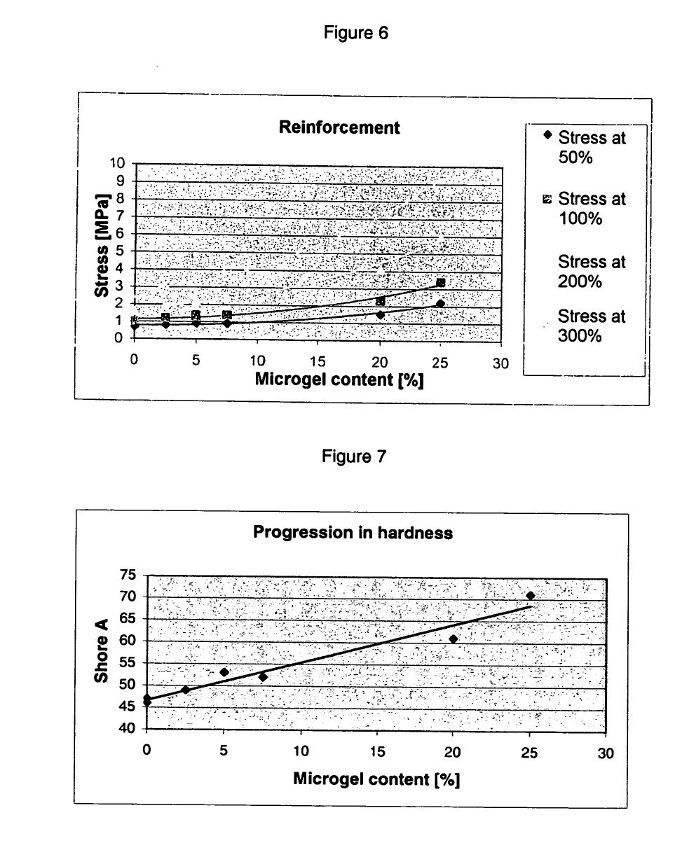

FIG. 6 shows the reinforcement for the system “RC-Phen 123-RFL 403B-RC-DUR 110”; RT (processing by machine).

FIG. 7 shows the progression in hardness for the system “RC-Phen 123-RFL 403B-RC DUR 110”; RT (processing by machine). FIG. 7 shows that the hardness increases by the addition of microgel from 46 Shore A to 71 Shore A.

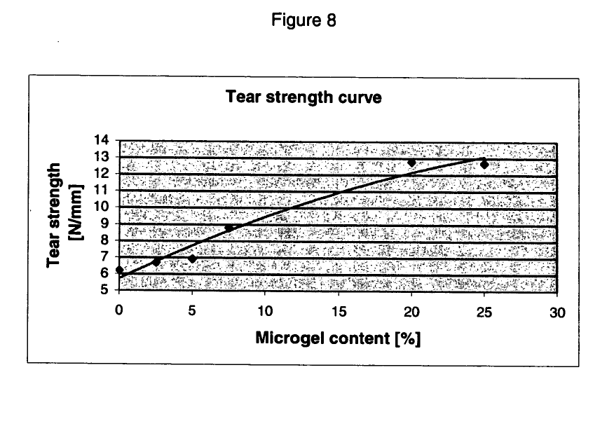

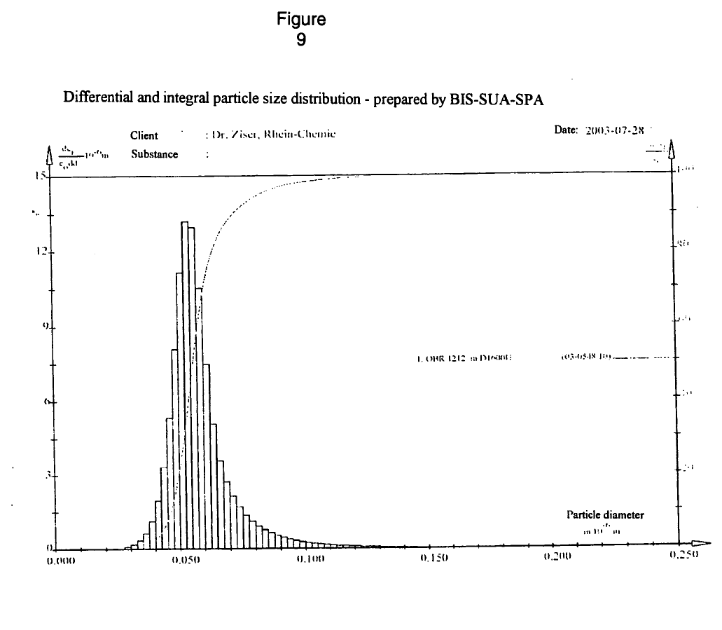

FIG. 8 shows the tear strength of the system “RC-Phen123-RFL 403B-RC DUR110”; RT (processing by machine). FIG. 8 shows that the tear strength increases by the addition of microgel from 6 Nmm⁻¹ to 13 Nmm⁻¹.

### Example 4

### Hydroxyl-Group-Modified SBR Gels (OBR 1212) in Desmophen 1600U

In the Example described below it is shown that compositions according to the invention that contain principally primary particles having a mean particle diameter mainly of about 60 nm can be prepared using hydroxyl-group-modified SBR-based microgels in a homogeniser by application of from 900 to 1000 bar.

The composition of the microgel paste is indicated in the table below:

| | | |
|---|---|---|
| 1. | Desmophen 1600 U | 90.000 |
| 2. | OBR 1212 | 10.000 |
| | Total | 100.000 |

Desmophen 1600 U is a commercial product/polyol (polyether) from Bayer AG.

OBR 1212 is a crosslinked, surface-modified SBR-based rubber gel from RheinChemie Rheinau GmbH. OBR 1212 consists of 46.5 wt. % butadiene, 31 wt. % styrene, 12.5 wt. % trimethylolpropane trimethacrylate (TMPTMA) and 10 wt. % hydroxyethyl methacrylate (HEMA). OBR 1212 was prepared analogously to RFL 403A.

For the preparation of the composition according to the invention, Desmophen 1600U was placed in a vessel and OBR 1212 was added with stirring by means of a dissolver. The mixture was left to stand for at least one day and was then processed further by means of a homogeniser.

The composition according to the invention was introduced into the homogeniser at room temperature and was passed through the homogeniser 4 times in batch operation at from 900 to 1000 bar. The microgel paste warms to about 40° C. during the first pass and to about 70° C. during the second pass. The microgel paste was then cooled to room temperature and dispersed a third and fourth time.

The particle diameter of the latex particles is determined by means of ultracentrifugation (W. Scholtan, H. Lange, “Bestimmung der Teilchengröβenverteilung von Latices mit der Ultrazentrifuge”, Kolloid-Zeitschrift und Zeitschrift für Polymere (1972) Volume 250, Number 8).

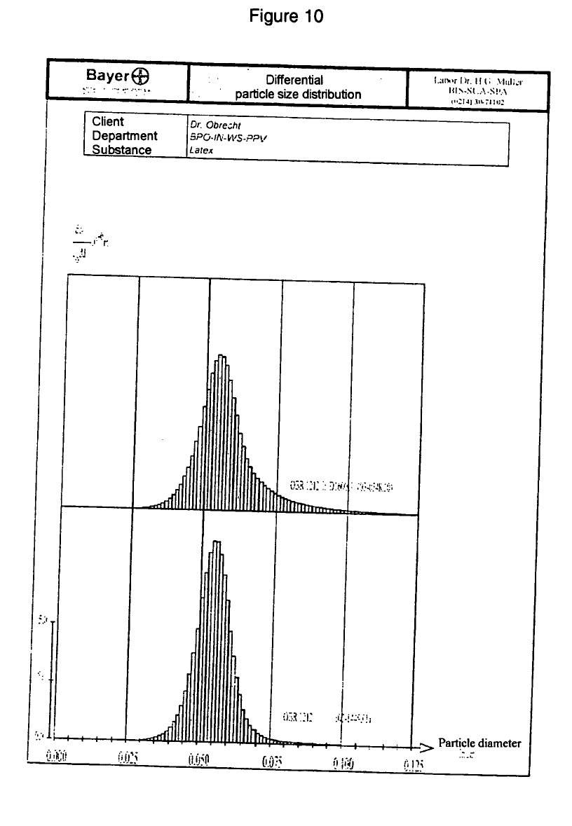

FIG. 9 shows the differential and integral particle size distribution of OBR 1212 in Desmophen 1600U. In FIG. 9 it is clear that it has been possible to redisperse solid OBR 1212 in Desmophen 1600U. The mean particle diameters of the OBR latex and of the redispersed OBR 1212 scarcely differ (see FIG. 10). In both materials, primary particles are present above all.

FIG. 10 shows the differential particle size distribution of OBR 1212 latex and of OBR 1212, redispersed in Desmophen 1600U, in comparison.

### Example 5

### Hydroxyl-Group-Modified SBR Gels Having Glass Transition Temperatures Below 20° C. in RC-Phen E 123

In the Example described below it is shown that, using hydroxyl-group-modified SBR-based microgels, improved properties are to be demonstrated after curing in compositions according to the invention dispersed using a homogeniser, which properties are due to the microgels.

The composition of a microgel paste containing 15% microgel is indicated by way of example in the table below (amounts in wt. %):

| | | |
|---|---|---|
| 1. | RC -Phen 123 | 79.30 |
| 2. | Activator mixture | 0.065 |
| 3. | Microgel* | 15.00 |
| 4. | T-Paste | 5.635 |
| | Total | 100 |

*SBR-based microgel with different hydroxyl contents (resulting from HEMA addition)
T-Paste is a commercial product from UOP.

The blends used differ in respect of the amount and type of microgel used. RC-Phen E 123 is an unactivated polyol blend for the preparation of PUR by the cold casting process from RheinChemie Rheinau GmbH.

The crosslinking component used is RC-DUR 110, an aromatic polyisocyanate from RheinChemie Rheinau GmbH. The activator mixture consists mainly of RC-PUR activator 105E and 50 wt. % Mesamoll. RC-PUR activator 105E is a PU additive from RheinChemie Rheinau GmbH. The microgels OBR 1211, OBR 1212 and OBR 1223 are crosslinked, surface-modified SBR-based rubber gels from RheinChemie Rheinau GmbH. The microgels are prepared analogously to Example 1 for RFL 403 A (see table below).

The density of RC-Phen E 123 is 1.0 g/ml; the density of microgels is usually about 0.96 g/ml, that is to say the density of polyols hardly changes at all as a result of the incorporation of microgels, in contrast to inorganic fillers.

TABLE
Composition of the microgels OBR 1211, OBR 1212 and OBR
1223.

| Name | Butadiene | Styrene | TMPTMA | HEMA | Notes |
|---|---|---|---|---|---|
| OBR 1211 | 49.5 | 33 | 12.5 | 5 | — |
| OBR 1212 | 46.5 | 31 | 12.5 | 10 | — |
| OBR 1223 | 49.5 | 33 | 12.5 | 0 | instead of |
| | | | | | HEMA -> |
| | | | | | 4.5 phm |
| | | | | | ethoxyethylene |
| | | | | | glycol |
| | | | | | methacrylate |

For the preparation of the composition according to the invention, RC-Phen E 123 was placed in a vessel and the particular OBR microgel in question was added with stirring by means of a dissolver. The mixture was left to stand for at least one day and was then processed further by means of a homogeniser. The composition according to the invention was introduced into the homogeniser at room temperature and was passed through the homogeniser four times in batch operation at from 900 to 1000 bar. The microgel paste warms to about 40° C. during the first pass and to about 70° C. during the second pass. The microgel paste was then cooled to room temperature by being left to stand and the operation was repeated until four passes had been achieved. Thereafter, the activator mixture and T-Paste were added. The amount of activator was in each case so chosen that a processing time of about 3 minutes was achieved. The composition according to the invention was reacted with RC-DUR 110 (on the basis of the hydroxyl numbers determined analytically in the system microgel+polyol, the isocyanate amount was so chosen that a 6% excess was used in each case) to form a polymer belonging to the class of the cold-cast polymers.

By the addition of the microgels to the polyol component of RC-Phen E 123, the properties described hereinafter are achieved (see tables below).

The Shore A hardness was measured according to DIN 53505, the rebound resilience according to DIN 53512, the tensile properties according to EN ISO 527-1 (standard rods S2 prepared according to DIN 53504) and the tear strength according to DIN 53515 at room temperature (about 23° C.).

TABLE
Hardness, tear strength and rebound resilience of the system
“RC-Phen 123 - OBR microgel - RC DUR 110”; RT.

| | | | Tear | Rebound |
|---|---|---|---|---|
| | Microgel content | Shore A | strength | resilience |
| Name | [%] | [ ] | [N/mm] | [%] |
| RC- Phen 123-43 | 0% (undispersed) | 52 | 5.1 | 47.8 |
| RC- Phen 123-42 | 0% (dispersed) | 52 | 5.4 | 47.2 |
| RC- Phen 123-30 | 5% OBR1211 | 53 | 5.1 | 45.6 |
| RC- Phen 123-34 | 5% OBR1212 | 53 | 5.0 | 46.8 |
| RC- Phen 123-33 | 15% OBR1223 | 52 | 5.3 | 45.5 |

It is clear from the table above that the tested low-T_{g} microgels bring about hardly any changes in the elastomeric polyurethane (PU); however, advantages in terms of the viscosity behaviour are obtained, as shown hereinbelow.

TABLE
Stress at 50%, 100%, 200% and 300% elongation for the system
“RC-Phen 123 - OBR microgel - RC DUR 110”; room temperature (RT).

| | | Stress | Stress | Stress | Stress | | Stress at |
|---|---|---|---|---|---|---|---|
| | Microgel content | σ₅₀ | σ₁₀₀ | σ₂₀₀ | σ₃₀₀ | σ₃₀₀/ | break σ_{B} |
| Name | [%] | [MPa] | [MPa] | [MPa] | [MPa] | σ₁₀₀ | [MPa] |
| RC - Phen 123-43 | 0% (undispersed) | 0.94 | 1.3 | 2.1 | 3.1 | 2.4 | 4.4 |
| RC - Phen 123-42 | 0% (dispersed) | 0.99 | 1.4 | 2.2 | 3.3 | 2.4 | 4.6 |
| RC - Phen 123-30 | 5% OBR1211 | 0.94 | 1.4 | 2.3 | 3.7 | 2.6 | 4.7 |
| RC - Phen 123-34 | 5% OBR1212 | 0.88 | 1.3 | 2.1 | 3.5 | 2.7 | 3.6 |
| RC - Phen 123-33 | 15% OBR1223 | 0.87 | 1.3 | 2.1 | 3.2 | 2.5 | 4.2 |

The low-T_{g} microgels studied show that the ratio of the tensile stresses at 300% elongation and 100% elongation is increased compared with microgel-free PU.

These microgels can advantageously be used to modify the rheology of the polyol component, the density of the system remaining virtually unchanged.

TABLE
Rheology behaviour: viscosity η at different shear speeds v for the system
“RC-Phen 123 - OBR microgel”; 20° C.

| | | Viscosity η at | Viscosity η | Viscosity η | Viscosity η |
|---|---|---|---|---|---|
| | | ν = 5 sec⁻¹ | ν = 100 sec⁻¹ | ν = 1000 sec⁻¹ | ν = 0.1 sec⁻¹ |
| | Characteristics/ | (20° C.) | (20° C.) | (20° C.) | (20° C.) |
| Name | microgel content | [mPas] | [mPas] | [mPas] | [mPas] |
| RCPhen123-42 | 2 × 940 bar(0%) | 1150 | 1170 | 1170 | not determined |
| RCPhen123-30 | 2 × 940 bar | 2450 | 1880 | 1580 | not determined |
| | OBR1211(5%) | | | | |
| RCPhen123-30 | 4 × 990 bar | 2570 | 1900 | 1580 | not determined |
| | OBR1211(5%) | | | | |
| RCPhen123-34 | 2 × 970 bar | 1600 | 1550 | 1500 | not determined |
| | OBR1212(5%) | | | | |
| RCPhen123-34 | 4 × 940 bar | 1540 | 1480 | 1460 | not determined |
| | OBR1212(5%) | | | | |
| RCPhen123-33 | 2 × 950 bar | 26900 | 3370 | 2440 | 19600 |
| | OBR1223(15%) | | | | |
| RCPhen123-33 | 4 × 960 bar | 15400 | 3270 | 2390 | 16000 |
| | OBR1223(15%) | | | | |

Microgel-free RC-Phen 123 exhibits Newtonian flow behaviour; RC-Phen 123 containing 5% OBR 1212 also possesses approximately Newtonian flow behaviour.

RC-Phen 123 containing 5% OBR 1223 is highly thixotropic.

TABLE
Viscosity η at different shear speeds ν for the system “RC-Phen 123-OBR microgel 1212 or OBR 1223”; 20° C.

| | | Viscosity η | Viscosity η | Viscosity η | Viscosity η | Quotient |
|---|---|---|---|---|---|---|
| | | at ν = 5 sec⁻¹ | ν = 100 sec⁻¹ | ν = 1000 sec⁻¹ | ν = 0.1 sec⁻¹ | η (0.1 sec⁻¹)/ |
| | | (20° C.) | (20° C.) | (20° C.) | (20° C.) | η (1000 sec⁻¹) |
| Name | Characteristics | [mPas] | [mPas] | [mPas] | [mPas] | [ ] |
| RC-Phen123-34 MV | OBR1212 (5%) | 20600 | 2580 | 1740 | 120000 | 69.0 |
| | dissolver | | | | | |
| RC-Phen123-34 MV | OBR1212 (5%) | 1910 | 1770 | 1660 | 3090 | 1.9 |
| | 1 × 970 bar | | | | | |
| RC-Phen123-35 MV | OBR1212 (15%) | 54700 | 4100 | 2240 | 116000 | 51.8 |
| without activator | dissolver | | | | | |
| RC-Phen123-35 MV | OBR1212 (15%) | 2600 | 2310 | 2150 | 1270 | 0.6 |
| without activator | 1 × 950 bar | | | | | |
| RC-Phen123-35 MV | OBR1212 (15%) | 3090 | 2770 | 2630 | 2110 | 0.8 |
| without activator | 3 × 950 bar | | | | | |
| RC-Phen123-33 MV | OBR1223 (15%) | 602000 | 4510 | 2340 | 72200 | 30.9 |
| with activator | dissolver | (at 5.32 s⁻¹) | | | | |
| RC-Phen123-33 MV | OBR1223 (15%) | 57900 | 3220 | 2390 | 25100 | 10.5 |
| with activator | 1 × 960 bar | | | | | |
| RC-Phen123-33 MV | OBR1223 (15%) | 12000 | 2730 | 2240 | 15400 | 6.9 |
| with activator | 3 × 960 bar | | | | | |

It is clear from the above table that the thickening (thixotropy or intrinsic viscosity) is most pronounced for the undispersed mixtures. OBR 1212 is already well dispersed on passage through the homogeniser, so that the resulting viscosities of the mixtures are low and are similar to one another even at 15% OBR 1212.

OBR 1223 thickens markedly more than OBR 1212; the mixtures are highly thixotropic. This shows that the rheological behaviour is dependent on the nature of the microgel. This can be used to influence the rheological behaviour in a simple manner by the choice of microgel.

In contrast to these microgels, the next Example describes microgels having glass transition temperatures above room temperature in RC-Phen E 123.

### Example 6

### Hydroxyl-Group-Modified Microgels Having Glass Transition Temperatures Above Room Temperature (200) in RC-Phen E 123

In the Example described below it is shown that, using hydroxyl-group-modified SBR-, SNBR- and acrylonitrile-based microgels, improved properties are to be demonstrated after curing in compositions according to the invention dispersed using a homogeniser, which properties are due to the nanoparticles.

Compositions of various microgel pastes are indicated by way of example in the table below:

| | | | | | | |
|---|---|---|---|---|---|---|
| 1. | RC-Phen 123 | 89.98 | 74.955 | 89.97 | 79.85 | 74.8 |
| 2. | Activator mixture | 0.02 | 0.045 | 0.03 | 0.15 | 0.2 |
| 3. | SBR microgel | 5.00 | 20.00 | | | |
| 4. | ACN microgels | | | 5.00 | 15.00 | 20.00 |
| 5. | L-Paste | 5.00 | 5.00 | 5.00 | 5.00 | 5.00 |
| | Total | 100 | 100 | 100 | 100 | 100 |
| | Crosslinker | about | about | about | 25.6 | about |
| | RC-DUR 110 | 28.3 | 24.1 | 28.3 | | 23.9 |

RC-Phen E 123 is an unactivated polyol blend for the preparation of PUR by the cold casting process from RheinChemie Rheinau GmbH. The crosslinking component used is RC-DUR 110, an aromatic polyisocyanate from RheinChemie Rheinau GmbH. The activator mixture consists of 10% RC-PUR activator 201N and 90 wt. % Mesamoll (Bayer AG). RC-PUR activator 201N is a PU additive from RheinChemie Rheinau GmbH. The microgels are crosslinked, surface-modified SBR-, ACN- or SNBR-based rubber gels from RheinChemie Rheinau GmbH. The microgels are prepared as described in Example 1 for RFL 403A.

TABLE
Composition of the high-T_{g} microgels used.

| Name | Acrylonitrile | Butadiene | Styrene | TMPTMA¹⁾ | HEMA²⁾ | Notes |
|---|---|---|---|---|---|---|
| OBR 1318A | — | 11.3 | 75.7 | 3 | 10 | |
| OBR 1318B | 10 | 10.1 | 66.9 | 3 | 10 | |
| OBR 1319B | — | 12.0 | 80.0 | 3 | 5 | |
| Micromorph | — | 12 | 80 | — | 3 | 5 EGDMA³⁾ |
| 1P | | | | | | |
| Micromorph | — | 12 | 80 | — | 3 | with 5 wt. % |
| 1P⁵⁾ | | | | | | Levasil |
| | | | | | | 300/30 (s/s) |
| Micromorph | — | 12 | 80 | — | 3 | with 10 wt. % |
| 1P⁵⁾ | | | | | | Levasil |
| | | | | | | 300/30 (s/s) |
| Micromorph | — | 12 | 80 | — | 3 | with 25 wt. % |
| 1P⁵⁾ | | | | | | Levasil |
| | | | | | | 300/30 (s/s) |
| OBR 1163 | — | 46.2 | 30.8 | — | 3 | 20 DVB⁴⁾ |
| OBR 1287 | 84 | — | — | 6 | 10 | |
| OBR 1288 | 88.5 | — | — | 1.5 | 10 | |
| OBR 1295 | 94 | — | — | 6 | — | |

¹⁾trimethylolpropane trimethacrylate
²⁾2-hydroxyethyl methacrylate
³⁾ethylene glycol dimethacrylate
⁴⁾divinylbenzene
⁵⁾prpared by mixing Micromorph 1 L (latex) and Levasil 300/30 and subsequent spray drying. In order to stabilise the latex, 1% Acticide MBS was added.
L-Paste is a commercial product from UOP.
Levasil 300/30 is a commercial product from H. C. Starck.
Acticide MBS is a commercial product from Thor GmbH.

L-Paste is a commercial product from UOP. Levasil 300/30 is a commercial product from H. C. Starck.

Acticide MBS is a commercial product from Thor GmbH.

For the preparation of the composition according to the invention, RC-Phen E 123 was placed in a vessel and the particular OBR microgel in question was added with stirring by means of a dissolver. The mixture was left to stand for at least one day and was then processed further by means of a homogeniser. The composition according to the invention was introduced into the homogeniser at room temperature and was passed through the homogeniser six times in batch operation at from 900 to 1000 bar. The microgel paste warms to about 40° C. during the first pass and to about 70° C. during the second pass. The microgel paste was then cooled to room temperature by being left to stand and the operation was repeated until six passes had been achieved. Thereafter, the activator mixture and L-Paste were added. The amount of activator was in each case so chosen that a processing time of about 3 minutes was achieved. The composition according to the invention was reacted with RC-DUR 110 (on the basis of the hydroxyl numbers determined analytically in the system microgel+polyol, the isocyanate amount was so chosen that a 6% excess was used in each case) to form a polymer belonging to the class of the cold-cast polymers.

By the addition of the microgels to the polyol component of RC-Phen E 123, the properties described hereinafter are achieved (see table below).

The Shore A hardness was measured according to DIN 53505, the rebound resilience according to DIN 53512, the tensile properties according to EN ISO 527-1 (standard rods S2 prepared according to DIN 53504), the permanent set according to DIN 53517 and the tear strength according to DIN 53515 at room temperature (about 23° C.).

TABLE
Hardness according to Shore A, rebound resilience, elongation at break δₘₐₓ, maximum stress σₘₐₓ, tear strength
and σ_{300/}σ₁₀₀ for the system “RC-Phen 123 - microgel - RC DUR 110”, classified according to microgel and
microgel type; 23° C.

| | | | | | Elongation | Stress | Tear strength | |
|---|---|---|---|---|---|---|---|---|
| | Amount | | | | δₘₐₓ | σₘₐₓ | (test speed | Quotient of the |
| | of | | | Rebound | (200 mm/min; | (200 mm/min; | 500 mm/min; | tensile stresses |
| | microgel | | Shore A | resilience | 23° C.) | 23° C.) | 23° C.) | σ_{300/}σ₁₀₀ |
| Microgel | % | Preparation | hardness | [%] | [%] | [MPa] | [N/mm] | [ ] |
| — | 0 | 6 × 950 bar | 55 | 54.4 | 424 | 3.5 | 5.5 | 2.2 |
| — | 0 | dissolver | 54 | 52.3 | 442 | 4.8 | 5.6 | 2.2 |
| M. 1P | 5 | 6 × 950 bar | 61 | 52.8 | 437 | 6.0 | 7.2 | 2.3 |
| M. 1P | 20 | 6 × 950 bar | 72 | 44.6 | 298 | 6.3 | 9.8 | 2.2 |
| (20%) | | | | | | | | |
| M. 1P/ | 5 | 6 × 950 bar | 58 | 52.5 | 386 | 5.1 | 6.7 | 2.4 |
| 5% Levasil | | | | | | | | |
| M. 1P/ | 20 | 6 × 950 bar | 72 | 42.9 | 301 | 8.5 | 8.7 | 2.6 |
| 5% Levasil | | | | | | | | |
| M. 1P/ | 5 | 6 × 950 bar | 61 | 50 | 251 | 4.1 | 5.0 | — |
| 10% Levasil | | | | | | | | |
| M. 1P/ | 20 | 6 × 950 bar | 65 | 36.6 | 281 | 6.3 | 7.0 | 2.7 |
| 10% Levasil | | | | | | | | |

| | Amount | | | | | | Tear strength | |
|---|---|---|---|---|---|---|---|---|
| | of | | | | | | (test speed | Quotient of the |
| | microgel | | Shore A | Rebound | Elongation | Stress | 500 mm/min; | tensile stresses |
| Microgel | % | Preparation | hardness | resilience | δₘₐₓ | σₘₐₓ | 23° C.) | σ_{300/}σ₁₀₀ |
| M. 1P/ | 5 | 6 × 950 bar | 60 | 47.8 | 176 | 2.3 | 5.0 | — |
| 30% Levasil | | | | | | | | |
| M. 1P/ | 20 | 6 × 950 bar | 63 | 37.2 | 273 | 4.7 | 6.1 | 2.5 |
| 30% Levasil | | | | | | | | |
| OBR 1163 | 5 | 6 × 950 bar | 61 | 52.1 | 403 | 5.5 | 7.4 | 2.3 |
| OBR 1163 | 20 | 6 × 950 bar | 70 | 41.1 | 350 | 8.6 | 9.7 | 2.8 |
| OBR 1318A | 5 | 6 × 950 bar | 58 | 52.6 | 381 | 5.5 | 5.4 | 2.5 |
| OBR 1318A | 20 | 6 × 950 bar | 67 | 43.7 | 268 | 7.9 | 5.7 | 3.7 |
| OBR 1318B | 5 | 6 × 950 bar | 58 | 54 | 381 | 5.2 | 5.5 | 2.5 |
| OBR 1318B | 20 | 6 × 950 bar | 68 | 45.9 | 273 | 6.7 | 7.0 | 4.5 |
| OBR 1319B | 5 | 6 × 950 bar | 61 | 52.7 | 300 | 3.9 | 6.8 | 2.3 |
| ACN gels | | | | | | | | |
| OBR 1287 | 5 | 6 × 950 bar | 62 | 52.4 | 536 | 9.7 | 7.0 | 2.4 |
| OBR 1287 | 15 | 6 × 950 bar | 67 | 45.2 | 346 | 8.4 | 8.3 | 2.9 |
| OBR 1288 | 5 | 6 × 950 bar | 61 | 52.2 | 415 | 6.0 | 7.0 | 2.4 |
| OBR 1288 | 20 | 6 × 950 bar | 69 | 45.5 | 373 | 13.3 | 8.2 | 3.3 |
| OBR 1295 | 5 | 6 × 950 bar | 61 | 51.3 | 479 | 6.6 | 7.4 | 2.2 |
| OBR 1295 | 15 | 6 × 950 bar | 58 | 45.6 | 643 | 7.9 | 8.8 | 1.9 |

The above table shows that the tear strength, the reinforcing action, the Shore A hardness and the rebound resilience of the resulting microgel-containing polymer compositions are affected by the nature and amount of the microgels used.

TABLE
Permanent set (PS), duration 24 h/temperature 100° C. for some
systems “RC-Phen 123 - Microgel - RC DUR 110”; measuring
temperature: 23° C.

| | | Height after | | |
|---|---|---|---|---|
| | Original | removal of | | |
| | height | stress | PS | Mean PS |
| Sample | [mm] | [mm] | [%] | [%] |
| 0%, | 6.1 | 5.61 | 32.0 | 32.4 |
| homogenised | 6.16 | 5.64 | 32.7 | |
| OBR 1318A | 6.09 | 5.80 | 19.1 | 19.4 |
| (20%) | 6.15 | 5.84 | 19.6 | |
| M. 1P/ | 6.09 | 5.79 | 19.7 | 19.3 |
| 5% Levasil | 6.11 | 5.82 | 18.8 | |
| (20%) | | | | |

In the above table it is shown that hydroxyl-modified microgels can give positive permanent sets for the resulting microgel-containing polymer compositions.

1. Composition comprising at least one crosslinkable organic medium (A) that has a viscosity of less than 30,000 mPas at a temperature of 120° C., and at least one microgel (B) that has not been crosslinked by means of high-energy radiation.

2. Composition according to claim 1, wherein the crosslinkable organic medium (A) has a viscosity of less than 10,000 mPas at a temperature of 120° C.

3. Composition according to claim 1, wherein the crosslinkable organic medium (A) has a viscosity of less than 1000 mPas at a temperature of 120° C.

4. Composition according to any one of claims 1 to 3, characterised in that the primary particles of the microgel (B) have approximately spherical geometry.

5. Composition according to claims 1 or 4, characterised in that the variation in the diameters of an individual primary particle of the microgel (B), defined as
[(d1−d2)/d2]×100,
wherein d1 and d2 are any two diameters of the primary particle and d1>d2, is less than 250%.

6. Composition according to any one of claims 1 to 5, characterised in that the primary particles of the microgel (B) have an average particle size of from 5 to 500 nm.

7. Composition according to any one of claims 1 to 6, characterised in that the primary particles of the microgel (B) have an average particle size of less than 99 nm.

8. Composition according to any one of claims 1 to 7, characterised in that the microgels (B) exhibit portions that are insoluble in toluene at 23° C. of at least about 70 wt. %.

9. Composition according to any one of claims 1 to 8, characterised in that the microgels (B) have a swelling index in toluene at 23° C. of less than about 80.

10. Composition according to any one of claims 1 to 9, characterised in that the microgels (B) have glass transition temperatures of from −100° C. to +120° C.

11. Composition according to any one of claims 1 to 10, characterised in that the microgels (B) have a breadth of the glass transition range of greater than about 5° C.

12. Composition according to any one of claims 1 to 11, characterised in that the microgels (B) are obtainable by emulsion polymerisation.

13. Composition according to any one of claims 1 to 12, characterised in that the microgel (B) is based on rubber.

14. Composition according to any one of claims 1 to 13, characterised in that the microgel (B) is based on homopolymers or random copolymers.

15. Composition according to any one of claims 1 to 14, characterised in that the microgel (B) has been modified by functional groups reactive towards C═C double bonds.

16. Composition according to any one of claims 1 to 15, wherein the crosslinkable organic medium (A) is crosslinkable via functional groups containing hetero atoms or via C═C groups.

17. Composition according to any one of claims 1 to 16, which comprises from 1 to 60 wt. % of the microgel (B), based on the total amount of the composition.

18. Composition according to any one of claims 1 to 17, characterised in that it comprises from 10 to 99 wt. % of the crosslinkable organic medium (A), based on the total amount of the composition.

19. Composition according to any one of claims 1 to 18, characterised in that it additionally comprises fillers and additives.

20. Composition according to any one of claims 1 to 19, characterised in that it has been prepared by mixing the crosslinkable medium (A) and the microgel (B) by means of a homogeniser, a bead mill, a three-roller mill, a single- or multi-shaft barrel extruder, a kneader and/or a dissolver.

21. Composition according to claim 20, characterised in that it has been prepared by means of a homogeniser, a bead mill or a three-roller mill.

22. Composition according to any one of claims 1 to 21, characterised in that it has a viscosity of from 25 mPas to 20,000,000 mPas at a speed of 5 s⁻¹, determined using a cone/plate measuring system according to DIN 53018, at 20° C.

23. Composition according to any one of claims 1 to 22, characterised in that the microgel (B) has a swelling index in toluene at 23° C. of less than about 80.

24. Composition according to any one of claims 1 to 23, characterised in that the microgel has been modified by hydroxyl groups.

25. Composition according to any one of claims 1 to 24, characterised in that the crosslinkable medium is at least one polyol, preferably a diol, or a mixture thereof.

26. Use of the composition according to any one of claims 1 to 25 in the preparation of microgel-containing polymers.

27. Use according to claim 26 in the preparation of microgel-containing thermoplastic elastomers.

28. Use of the composition according to any one of claims 1 to 25 in the production of moulded articles or coatings.

29. Process for the preparation of microgel-containing polymers by polymerisation of the composition according to any one of claims 1 to 25.

30. Compositions obtainable according to claim 29.

31. Use of the compositions according to claim 30 as moulded bodies or coatings.

32. Process for the production of moulded bodies or coatings by moulding or coating using the compositions according to any one of claims 1 to 25.

33. Process for the preparation of the composition according to any one of claims 1 to 25, characterised in that components (A) and (B) are together subjected to treatment by means of a homogeniser, a bead mill, a three-roller mill, a single- or multi-shaft barrel extruder, a kneader and/or a dissolver.

34. Process for the preparation of microgel-containing polymer compositions, which comprises mixing at least one crosslinkable organic medium (A) that has a viscosity of less than 30,000 mPas at a temperature of 120° C., and at least one microgel (B) that has not been crosslinked by means of high-energy radiation, then adding a crosslinker (C) for the crosslinkable medium (A) and subsequently crosslinking the composition.

35. Process according to claim 34, wherein the crosslinkable organic medium (A) is at least one polyol, preferably a diol, or a mixture thereof, and the crosslinker (C) is at least one polyisocyanate, preferably a diisocyanate, or a mixture thereof.

36. Process according to claim 34 or 35, wherein components (A) and (B) are mixed by means of a homogeniser, a bead mill, a three-roller mill, a single- or multi-shaft barrel extruder, a kneader and/or a dissolver.

37. Polymer composition obtainable according to any one of claims 34 to 36.

38. Arrangement comprising, in spatially separated form: the composition according to any one of claims 1 to 25 and a composition comprising a crosslinker (C) for the crosslinkable organic medium (A).

39. Use of microgels as a rheological additive, in particular as a thickener or thixotropic agent, in crosslinkable organic media that have a viscosity of less than 30,000 mPas at a temperature of 120° C.
